(19) United States
(12) Patent Application Publication
(10) Pub. No.: US 2007/0022894 A1
(43) Pub. Date: Feb. 1, 2007

(54) Printing press abnormal state display method and apparatus

(75) Inventor: Masaru Yamamoto, Ibaraki (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Komori Corporation

(21) Appl. No.: 11/493,490

(22) Filed: Jul. 25, 2006

(30) Foreign Application Priority Data
Jul. 27, 2005 (JP) 217232/2005

(51) Int. Cl. B41F 33/00

(52) U.S. Cl. 101/484

(57) ABSTRACT

In a printing press abnormal state display method, the current states of a plurality of elements of a printing press are detected. The detected current state of each element is compared with a normal state predetermined for the element. It is determined on the basis of the comparison result whether the current state of the element is abnormal. The abnormal state of only an element determined to be abnormal is displayed on the basis of the determination result. A printing press abnormal state display apparatus is also disclosed.

### BACKGROUND OF THE INVENTION

The present invention relates to a printing press abnormal state display method and apparatus which detect and display an abnormal state of an element of a printing press.

Conventionally, a monitor apparatus as disclosed in, e.g., Japanese Utility Model Laid-Open No. 5-16310 is used as an apparatus for displaying an abnormal state of an element of a printing press. This monitor apparatus displays the operation states of all elements related to the operation of a printing press. The operator determines an abnormal part by checking the operation states.

However, a printing press has many elements related to the operation. In the conventional printing press abnormal state display method, the operator must check the operation states of all elements and determines a part where abnormality occurs. This makes the burden heavy for the operator. In addition, since it takes time to specify a part that should preferentially be repaired, the printing press down time for repair becomes long, and the operating ratio of the printing press lowers.

### SUMMARY OF THE INVENTION

The present invention has been made to solve these problems, and has as its object to reduce burden for an operator in detecting abnormality in a printing press.

It is another object to prevent any decrease in operating ratio in case of abnormality in the printing press.

In order to achieve the above objects, according to an aspect of the present invention, there is provided a printing press abnormal state display method comprising the steps of detecting current states of a plurality of elements of a printing press, comparing the detected current state of each element with a normal state predetermined for the element, determining on the basis of a comparison result whether the current state of the element is abnormal, and displaying an abnormal state of only an element determined to be abnormal on the basis of a determination result.

According to another aspect of the present invention, there is provided a printing press abnormal state display apparatus comprising detection means for detecting current states of a plurality of elements of a printing press, comparison means for comparing the current state of each element detected by the detection means with a normal state predetermined for the element, determination means for determining on the basis of a comparison result by the comparison means whether the current state of the element is abnormal, and display control means for controlling to display an abnormal state of only an element determined to be abnormal on the basis of a determination result by the determination means.

### BRIEF DESCRIPTION OF THE DRAWINGS

FIG. 1 is a block diagram of a central control unit included in a printing press abnormal state display apparatus according to the first embodiment of the present invention;

FIG. 2 is a block diagram of a PLC control unit included in the printing press abnormal state display apparatus according to the first embodiment of the present invention;

FIGS. 3A to 3D are flowcharts of a processing operation corresponding to an abnormal state display program executed by the CPU of the central control unit;

FIGS. 4A and 4B are flowcharts of a processing operation corresponding to an abnormal state detection program executed by the CPU of the PLC control unit;

FIG. 5 is a view showing the storage contents of a memory that stores the current output states of elements of the printing press;

FIG. 6 is a view showing the storage contents of a memory that stores the current printing press state;

FIG. 7 is a view showing the storage contents of a memory that stores a normal state of the printing press corresponding to each state;

FIG. 8 is a view showing the storage contents of a memory that stores a normal state of the printing press corresponding to the current printing press state;

FIG. 9 is a view showing the storage contents of a memory that stores abnormal states;

FIG. 10 is a view showing the storage contents of a memory that stores abnormal states;

FIG. 11 is a view showing the storage contents of a memory that stores the current printing press state;

FIG. 12 is a view showing the storage contents of a memory that stores an abnormal state for display;

FIG. 13 is a view showing the storage contents of a memory that stores text data;

FIGS. 14A and 14B are views showing comparison of data storage conditions between a memory that stores a current abnormal state and a memory that stores a preceding abnormal state (when the current contents are the same as the preceding contents);

FIGS. 15A and 15B are views showing comparison of data storage conditions between the memory that stores a current abnormal state and the memory that stores a preceding abnormal state (when the current contents are different from the preceding contents);

FIG. 16 is a functional block diagram of the CPU of the central control unit;

FIG. 17 is a block diagram of a display control unit;

FIG. 18 is a functional block diagram of the CPU of the PLC control unit;

FIG. 19 is a block diagram of a comparison unit;

FIG. 20 is a block diagram of a central control unit included in a printing press according to the second embodiment of the present invention;

FIG. 21 is a block diagram of a PLC control unit included in the printing press according to the second embodiment of the present invention;

FIGS. 22A to 22F are flowcharts of a processing operation corresponding to an abnormal state display program executed by the CPU of the central control unit;

FIGS. 23A to 23D are flowcharts of a processing operation corresponding to an abnormal state detection program executed by the CPU of the PLC control unit;

FIG. 24 is a view showing the storage contents of a memory that stores device or function data;

FIG. 25 is a view showing the storage contents of a memory that stores abnormal states;

FIG. 26 is a view showing the storage contents of a memory that stores an abnormal state of each device or function;

FIG. 27 is a view showing the storage contents of a memory that stores an abnormal state for display;

FIG. 28 is a functional block diagram of the CPU of the central control unit;

FIG. 29 is a block diagram of a display control unit;

FIG. 30 is a functional block diagram of the CPU of the PLC control unit; and

FIG. 31 is a block diagram of a comparison unit.

### DESCRIPTION OF THE PREFERRED EMBODIMENTS

The embodiments of the present invention will be described in detail with reference to the accompanying drawings.

### First Embodiment

A printing press abnormal state display apparatus according to the first embodiment of the present invention includes a central control unit and an abnormal state detection unit (PLC control unit).

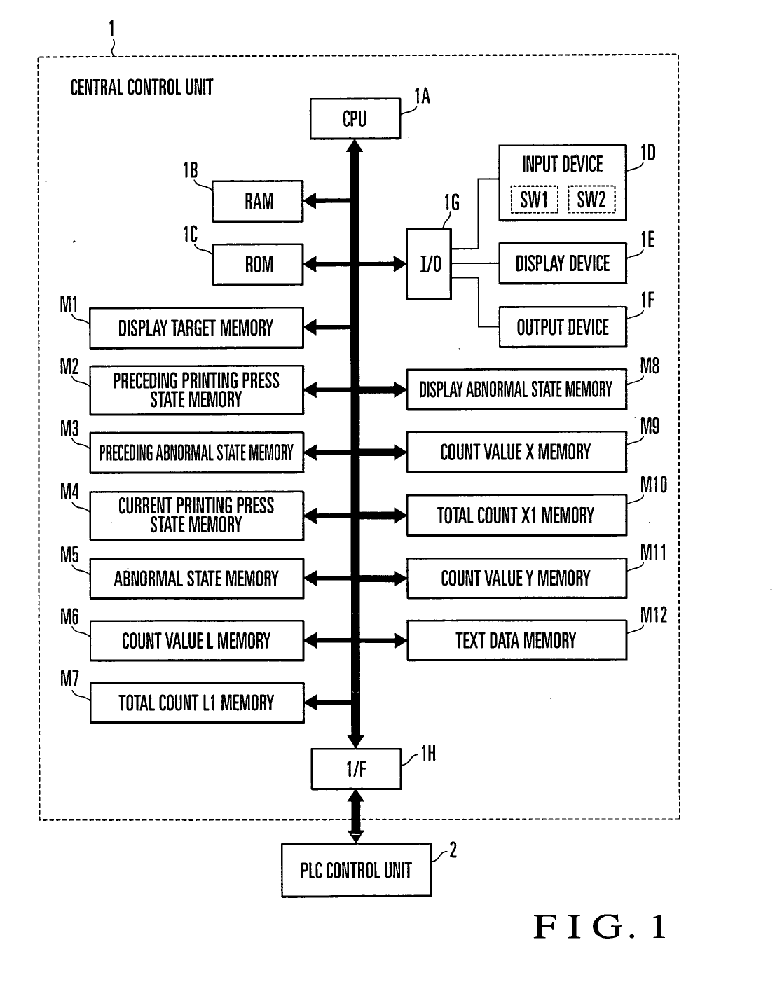

As shown in FIG. 1, a central control unit 1 comprises a CPU 1A, RAM 1B, ROM 1C, input device 1D, display device 1E, output device 1F, input/output interfaces (I/O I/Fs) 1G and 1H, and memories M1 to M12. The input device 1D has a device or function selector switch SW1 and a switch SW2 to return to a device or function selection menu. Examples of the display device 1E are an FD drive and a printer.

The CPU 1A operates in accordance with a program stored in the ROM 1C while acquiring various kinds of input information given through the interfaces 1G and 1H and accessing the RAM 1B and memories M1 to M12. The ROM 1C stores an abnormal state display program unique to this embodiment.

The memory M1 is a display target memory to store a selected device or function as an abnormal state display target. The memory M2 is a preceding printing press state memory to store the preceding state of the printing press. The memory M3 is a preceding abnormal state memory to store a preceding abnormal state. The memory M4 is a current printing press state memory to store the current printing press state detected by a PLC control unit 2. The memory M5 is an abnormal state memory to store an abnormal state detected by the PLC control unit 2. The memory M6 is a count value L memory to store a count value L. The memory M7 is a total count L1 memory to store a total count L1 of abnormality determination target portions corresponding to each printing press state. The memory M8 is a display abnormal state memory (display abnormal state storage means) to store an abnormal state for display. The memory M9 is a count value X memory to store a count value X. The memory M10 is a total count X1 memory to store a total count X1 of abnormality determination target portions corresponding to each printing press state and each device or function of the printing press. The memory M11 is a count value Y memory to store a count value Y. The memory M12 is a text data memory to store text data representing that an abnormality determination target portion set in correspondence with each printing press state and each device or function of the printing press is in an abnormal state.

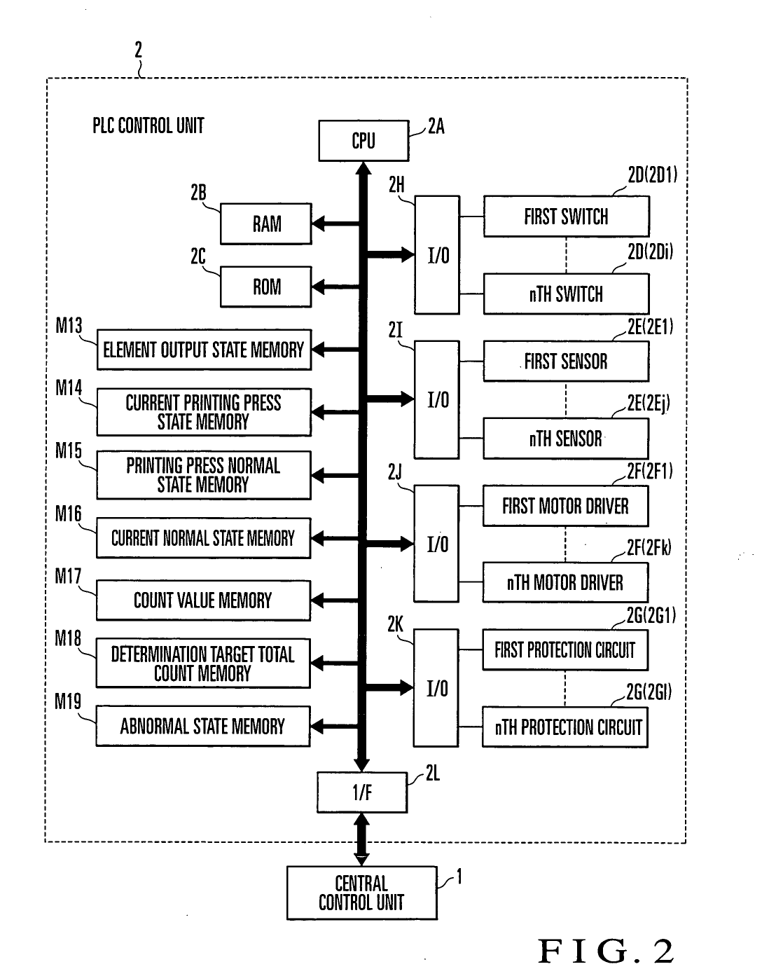

As shown in FIG. 2, the PLC control unit 2 comprises a CPU 2A, RAM 2B, ROM 2C, switches 2D1 to 2Di, sensors 2E1 to 2Ej, motor drivers 2F1 to 2Fk, protection circuits 2G1 to 2Gl, input/output interfaces (I/O I/Fs) 2H to 2L, and memories M13 to M19.

The switch 2D (2D1 to 2Di), sensor 2E (2E1 to 2Ej), motor driver 2F (2F1 to 2Fk), and protection circuit 2G (2G1 to 2Gl) are provided in correspondence with each of a plurality of elements as the abnormality determination target portions of the printing press. In this embodiment, i, j, k, and l that represent the numbers of switches 2D, sensors 2E, motor drivers 2F, and protection circuits 2G are independent numbers and do not always equal.

The CPU 2A operates in accordance with a program stored in the ROM 2C while acquiring various kinds of input information given through the interfaces 2H to 2L and accessing the RAM 2B and memories M13 to M19. The ROM 2C stores an abnormal state detection program unique to this embodiment.

The memory M13 is an element output state memory to store the current output state of each element of the printing press. The memory M14 is a current printing press state memory to store the current printing press state. The memory M15 is a printing press normal state memory to store a normal state corresponding to each printing press state. The memory M16 is a current normal state memory to store the normal state of the printing press corresponding to the current printing press state. The memory M17 is a count value memory to store a count value K. The memory M18 is a determination target total count memory to store a total count K1 of abnormality determination target portions corresponding to each printing press state. The memory M19 is an abnormal state memory to store an abnormal state.

In the above-described memories M5, M8, and M19, an area to store an abnormal state of an element is assigned in descending order of significances of elements. For example, an abnormal state of an element with higher significance is stored at an address of lower number.

The CPU 1A of the central control unit 1 is connected to the PLC control unit 2 through the interface (transmitting/receiving unit) 1H to transmit/receive information to/from the PLC control unit 2. The CPU 2A of the PLC control unit 2 is connected to the central control unit 1 through the interface (transmitting/receiving unit) 2L to transmit/receive information to/from the central control unit 1.

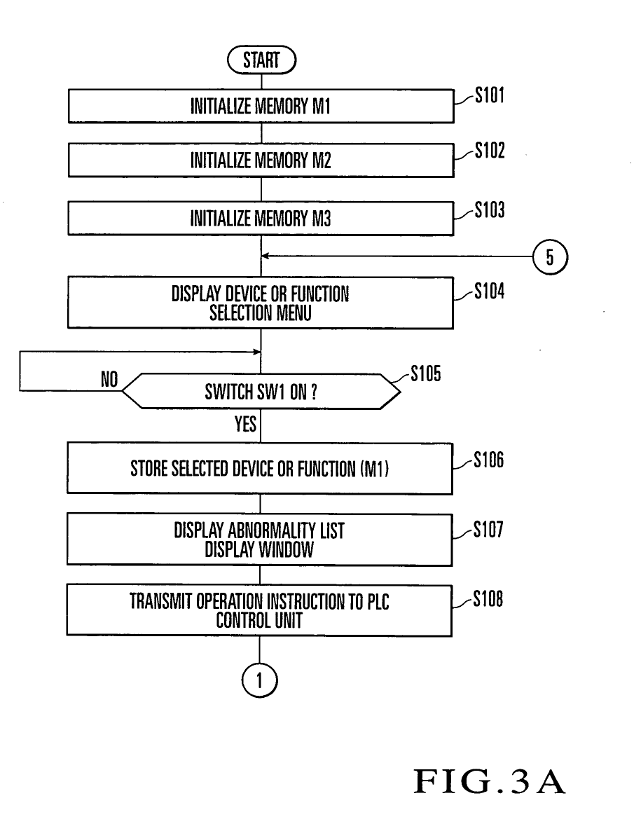

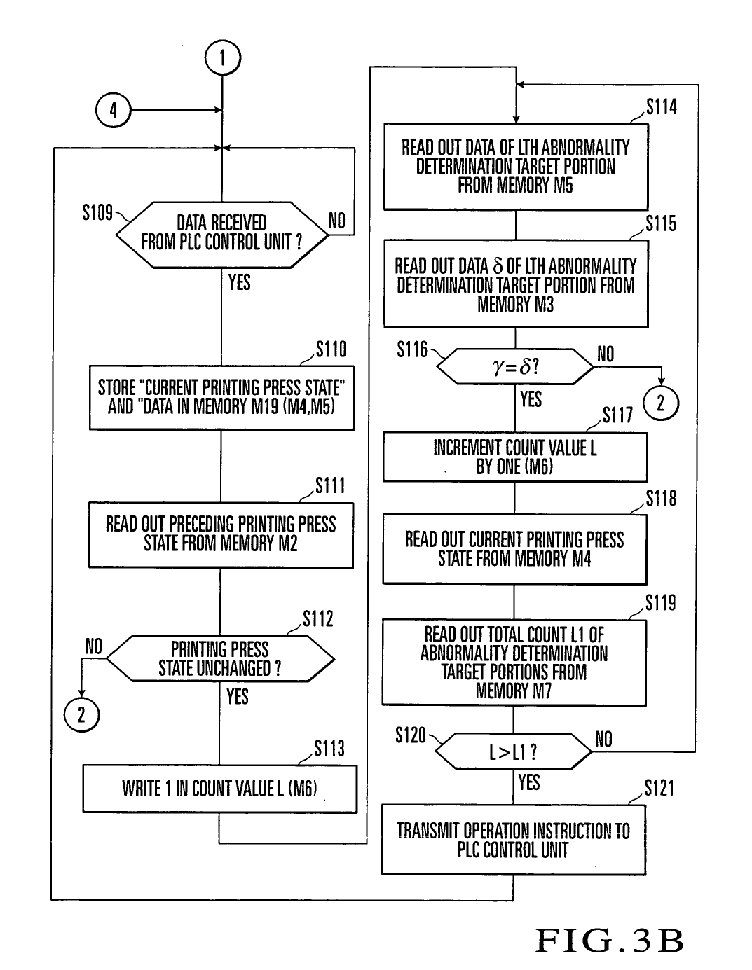

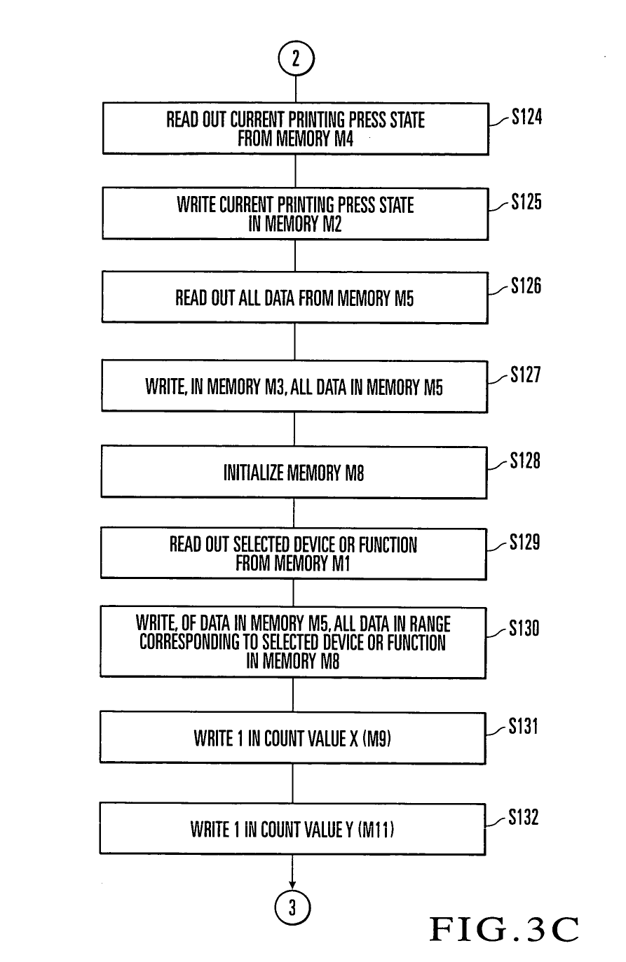

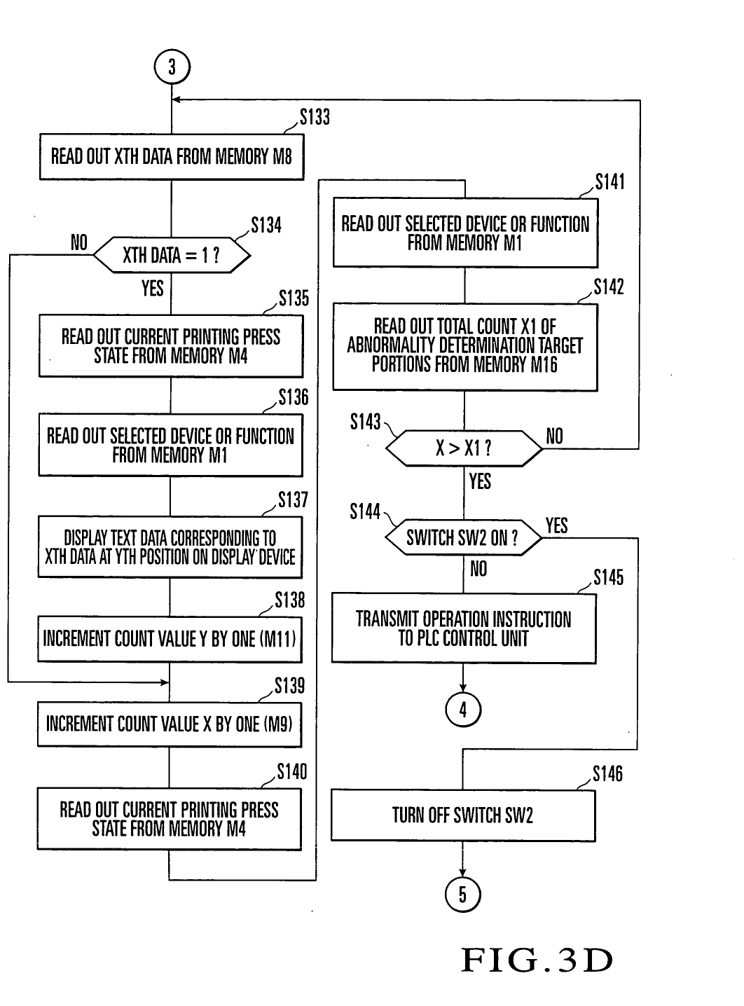

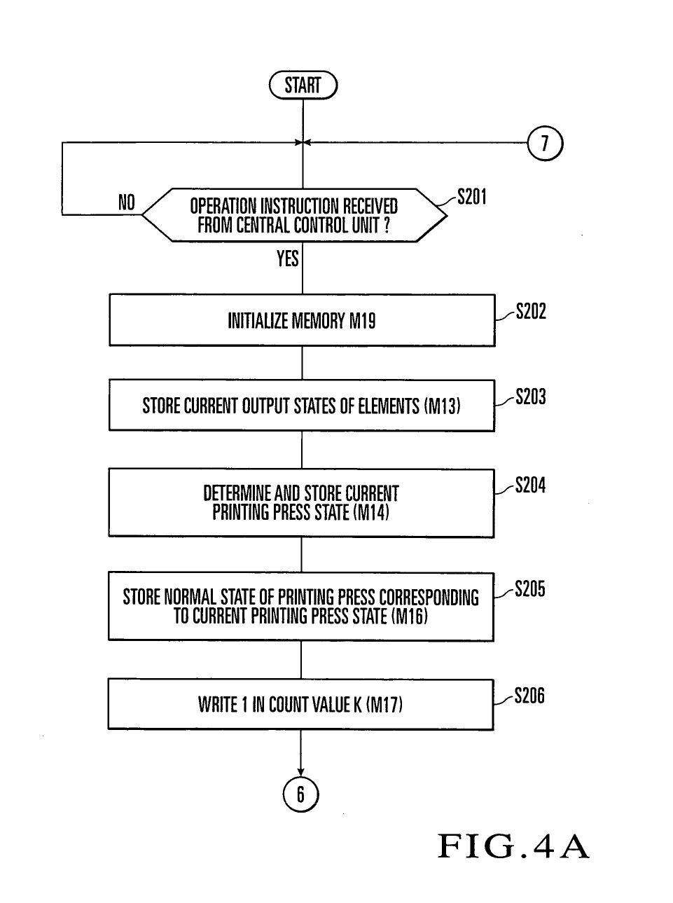

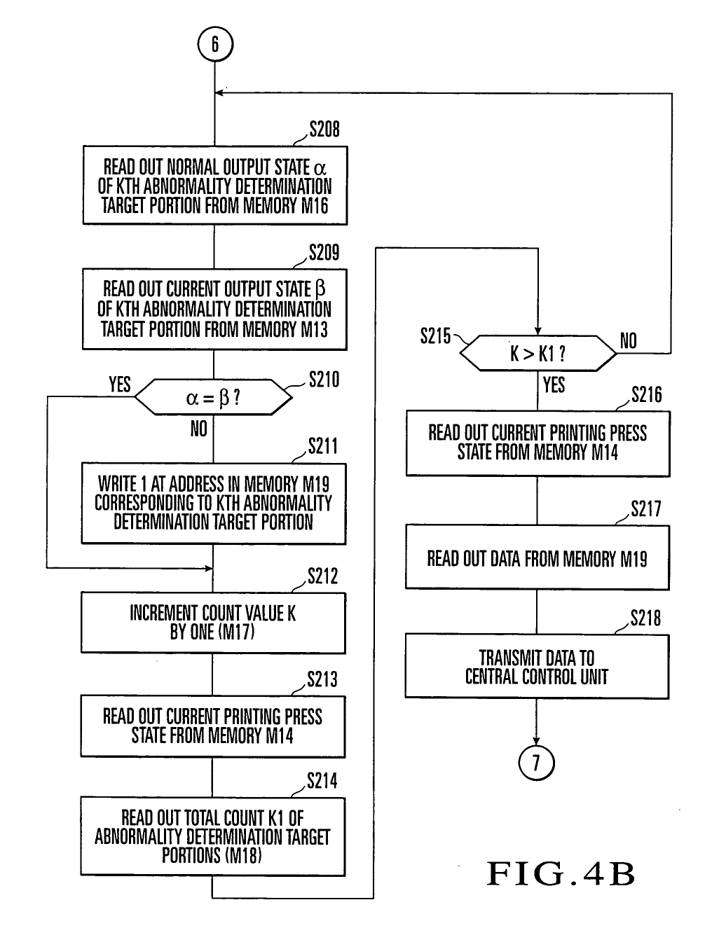

FIGS. 3A to 3D show a processing operation corresponding to the abnormal state display program executed by the CPU 1A of the central control unit 1. FIGS. 4A and 4B show a processing operation corresponding to an abnormal state detection program executed by the CPU 2A of the PLC control unit 2. The printing press abnormal state detection/display operation according to this embodiment, which is executed by cooperation of the central control unit 1 and PLC control unit 2, will be described below with reference to these flowcharts in association with the storage contents of the memories M1 to M19.

[Device or Function Selection in Central Control Unit]

Before the abnormal state detection/display operation, the CPU 1A of the central control unit 1 initializes the display target memory M1, preceding printing press state memory M2, and preceding abnormal state memory M3 (FIG. 3A: steps S101, S102, and S103). A device or function selection menu is displayed on the display device 1E (step S104). Various kinds of devices in the printing press and various kinds of functions in the printing press are displayed in the device or function selection menu. In this embodiment, first to Nth devices are provided in the printing press as devices, and first to Mth functions are provided in the printing press as functions. Examples of devices are a paper feed device, printing device, and discharge device. Examples of functions are the pile up-and-down function of the paper feed device, the high-speed operating function of the printing press, and the cleaning function of an ink device.

The operator who wants to know an abnormal state in the printing press selects, as an abnormal state display target, a desired device or function from the device or function selection menu displayed on the display device 1E and turns on the device or function selector switch SW1. Assume that the operator selects the first device as the abnormal state display target and turns on the device or function selector switch SW1. The CPU 1A confirms the ON state of the device or function selector switch SW1 (YES in step S105) and stores, in the memory M1, the selected first device as the abnormal state display target (abnormal state display target device) (step S106).

The CPU 1A displays an abnormality list display window on the display device 1E (step S107). Since the memory M3 has been initialized in step S103, i.e., the storage contents of preceding abnormal states have been cleared, no abnormal state is displayed yet in the abnormality list display window. After displaying the abnormality list display window, the CPU 1A sends an operation instruction to the PLC control unit 2 (step S108).

[Abnormal State Detection in PLC Control Unit]

[Storage of Current Output States of Elements (Abnormality Determination Target Portions) of Printing Press]

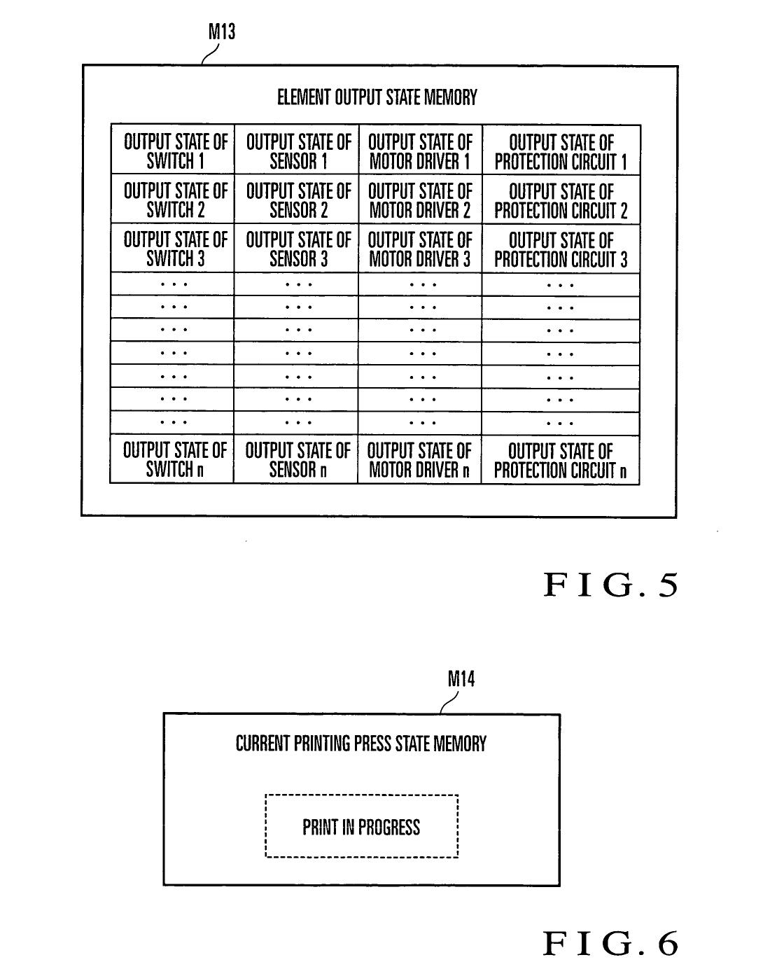

Upon receiving the operation instruction from the central control unit 1 (FIG. 4A: YES in step S201), the CPU 2A of the PLC control unit 2 initializes the abnormal state memory M19 (step S202). The output states of the switches 2D1 to 2Di, sensors 2E1 to 2Ej, motor drivers 2F1 to 2Fk, and protection circuits 2G1 to 2Gl are read from the I/Os 2H to 2K as the current output states of the elements (abnormality determination target portions) of the printing press and stored in the memory M13 (step S203: FIG. 5).

[Determination of Current Printing Press State]

The CPU 2A determines on the basis of the read current output states of the elements (abnormality determination target portions) of the printing press, the current printing press state, i.e., “print in progress”, “stop”, or the like and stores the determined current printing press state in the memory M14 (step S204). A description will be done here assuming that the current printing press state is determined to be “print in progress”. In this case, information representing “print in progress” is stored in the memory M14 as the current printing press state (FIG. 6).

[Storage of Normal State of Printing Press Corresponding to Current Printing Press State]

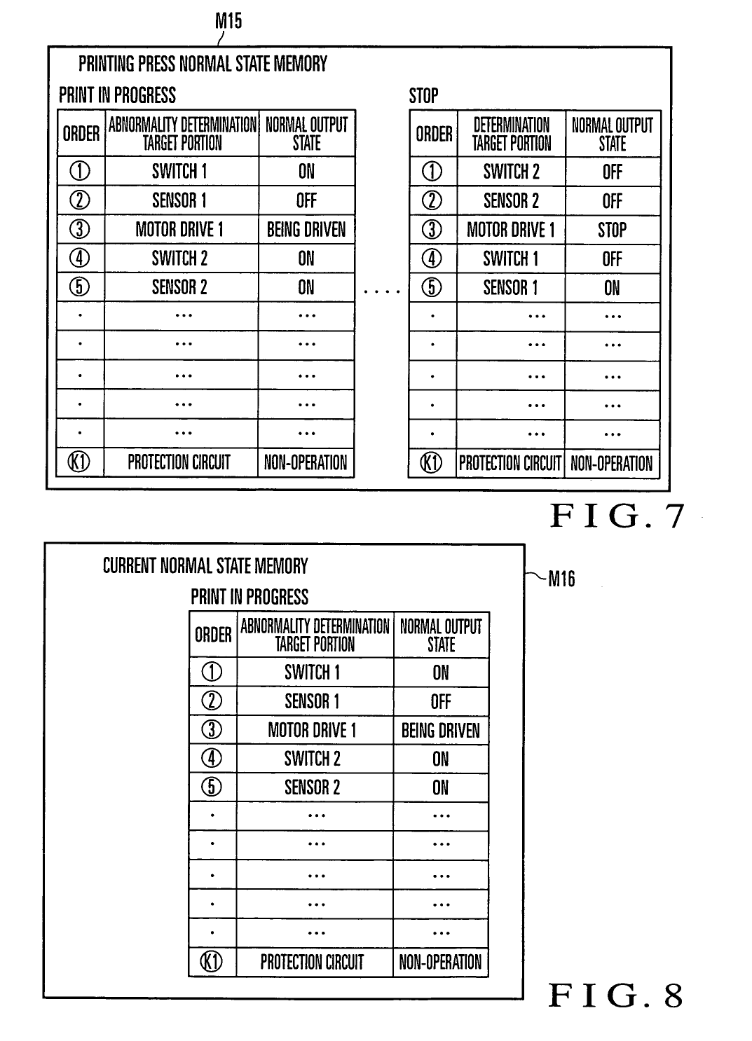

The CPU 2A reads out a corresponding normal state of the printing press from the memory M15 on the basis of the current printing press state determined in step S204 and stores the normal state in the memory M16 (step S205). FIG. 7 shows the storage situation of a normal state corresponding to each printing press state in the memory M15. FIG. 8 shows the storage situation of a normal state of the printing press corresponding to the current printing press state in the memory M16.

The memory M15 stores the normal output states of the abnormality determination target portions related to the printing press state in descending order of significances in correspondence with each printing press state. FIG. 7 representatively shows normal output states in the printing press in “print in progress” and “stop”. Related abnormality determination target portions in “print in progress” and those in “stop” are not always the same. The total count K1 of abnormality determination target portions indicates an independent number. The normal output states of abnormality determination target portions may change between “print in progress” and “stop”. The significances of related abnormality determination target portions may change between “print in progress” and “stop”, and their order is not always the same. The CPU 2A reads out, from the memory M15, the normal states in the printing press corresponding to the current printing press state (“print in progress” in this example) and stores the states in the memory M16, as shown in FIG. 8.

[Comparison Between Current Output State and Normal Output State of Each Abnormality Determination Target Portion and Normality/Abnormality Determination]

The CPU 2A writes “1” in the memory M17 as the count value K (step S206). The normal output state (α) of K=1st abnormality determination target portion is read out from the memory M16 (FIG. 4B: step S208). The current output state of the abnormality determination target portion corresponding to K=1st abnormality determination target portion in the memory M16 is read out from the memory M13 (step S209). The two output states are compared (step S210).

If the normal output state of K=1st abnormality determination target portion matches the current output state (YES in step S210), the CPU 2A determines that the current output state of K=1st abnormality determination target portion is normal, and the flow directly advances to step S212.

If the normal output state of K=1st abnormality determination target portion does not match the current output state (NO in step S210), the CPU 2A determines that the current output state of K=1st abnormality determination target portion is abnormal. The CPU 2A writes data indicating an abnormal state, i.e., “1” at an address corresponding to K=1st abnormality determination target portion in a range corresponding to the current printing press state (“print in progress” in this example) in the abnormal state memory M19. If K=1st abnormality determination target portion is related to a plurality of devices and functions, “1” is written at addresses corresponding to K=1st abnormality determination target portion in the ranges of all the devices and functions (step S211).

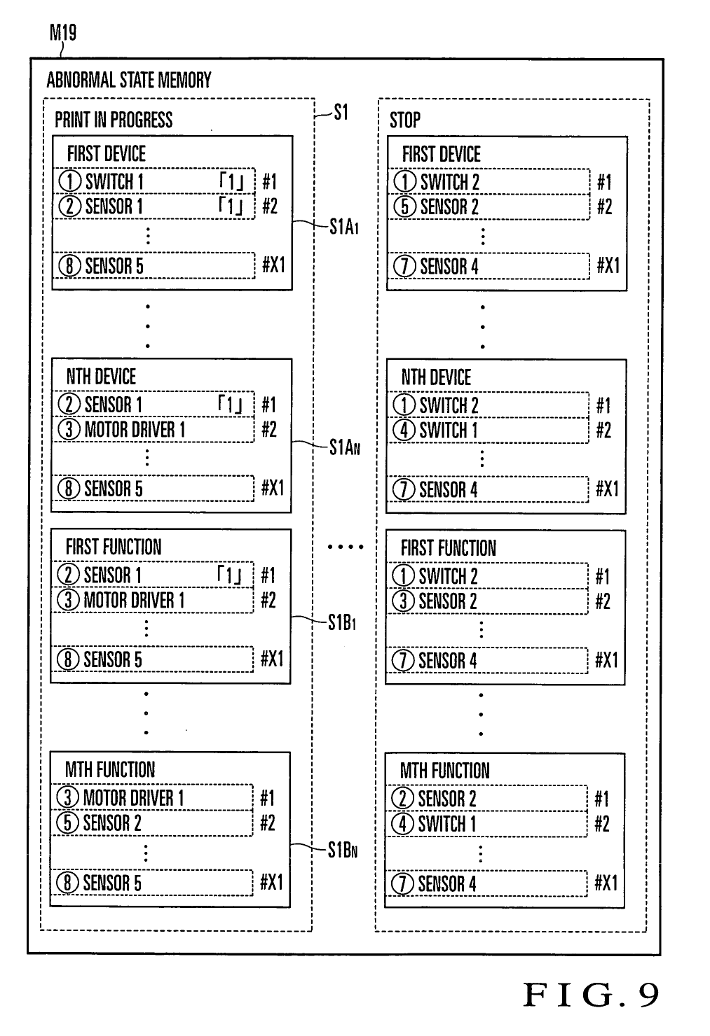

FIG. 9 shows the storage structure in the memory M19. The memory M19 stores abnormality determination target portions related to the first to Nth devices and first to Mth functions in the printing press in descending order of significances in correspondence with each printing press state. More specifically, abnormality determination target portions related to each device or function are provided in an order of addresses #1 , #2, . . . , #X1 (in descending order of significances) in a memory area corresponding to each device or function.

In this case, since the current printing press state is “print in progress”, a range S1 corresponding to “print in progress” in the memory M19 is selected. Assume that K=1st abnormality determination target portion is “switch 1”. In the illustrated range, a range S1A1 of the “first device” is selected as devices and functions related to “switch 1”. Hence, the CPU 2A writes “1” at an address corresponding to “switch 1” in the range S1A1 of the “first device” in the range S1 corresponding to “print in progress”.

The CPU 2A increments the count value K in the memory M17 by one to set K=2 (step S212). The CPU 2A reads out the current printing press state from the memory M14 (step S213) and, on the basis of the readout current printing press state, reads out, from the memory M18, the total count K1 of abnormality determination target portions corresponding to the current printing press state (step S214). Then, the processing operation in steps S208 to S215 is repeated until K>K1 holds in step S215.

With this operation, “1” is written at addresses corresponding to abnormality determination target portions in the ranges of all devices and functions related to the abnormality determination target portion determined to be abnormal in step S210. In this example, a description will be made assuming that only K=1st abnormality determination target portion (“switch 1”) and K=2nd abnormality determination target portion (“sensor 1”) are determined to be abnormal, and the remaining portions are normal.

When K>K1 (YES in step S215), the CPU 2A reads out the current printing press state from the memory M14 (step S216), reads out all data in the range corresponding to the current printing press state in the memory M19 (step S217), and transmits the data read out from the memory M19 to the central control unit 1 (step S218).

[Abnormal State Display in Central Control Unit]

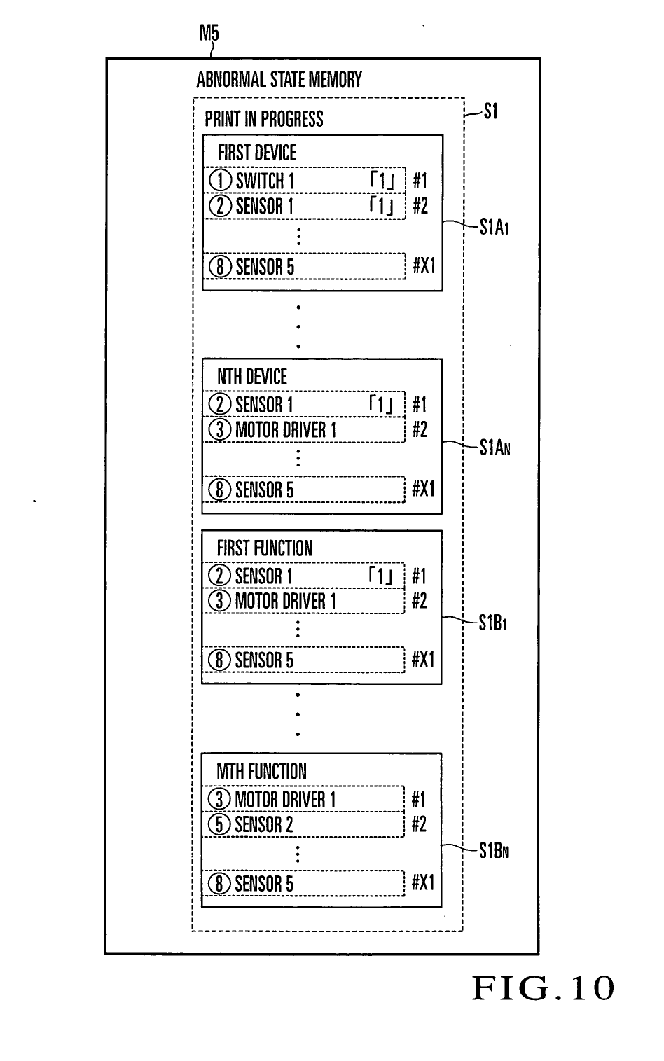

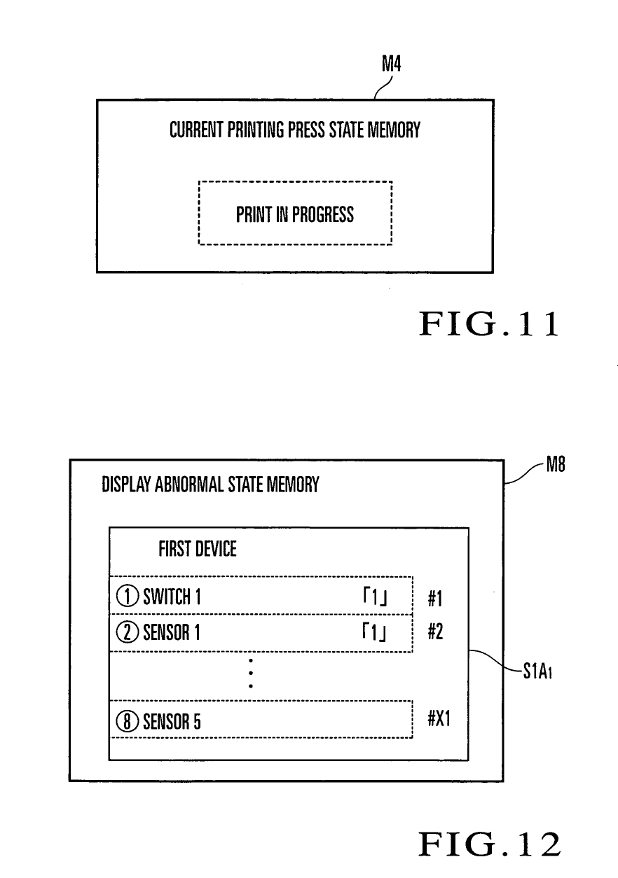

The CPU 1A of the central control unit 1 receives the “current printing press state” and “all data in the range corresponding to the current printing press state in the memory M19” from the PLC control unit 2 (FIG. 3B: YES in step S109) and stores the “current printing press state” in the memory M4 and “all data in the range corresponding to the current printing press state in the memory M19” in the memory M5 (step S110: FIGS. 10 and 11). [When Current Printing Press State is Different From Preceding Printing Press State]

The CPU 1A reads out the preceding printing press state from the memory M2 (step S111) and compares it with the current printing press state received from the PLC control unit 2 (step S112). Assume that the preceding printing press state is “stop” (NO in step S112)

In this case, the CPU 1A reads out the current printing press state from the memory M4 (FIG. 3C: step S124) and writes the readout current printing press state in the memory M2 as the preceding printing press state (step S125). The CPU 1A also reads out all data from the memory M5 (step S126) and writes them in the memory M3 as preceding abnormal state data (step S127).

The CPU 1A initializes the display abnormal state memory M8 (step S128) and reads out an abnormal state display target device or function from the memory M1 (step S129). Of the data in the memory M5, all data in a range corresponding to the abnormal state display target device or function are written in the memory M8 (step S130). In this example, the first device is stored in the memory M1 as the abnormal state display target device or function. Hence, all data in the range S1A1 corresponding to the first device in the memory M5 shown in FIG. 10 are written in the memory M8 (FIG. 12).

The CPU 1A writes “1” in the memory M9 as the count value X (step S131) and “1” in the memory M11 as the count value Y (step S132). The CPU 1A reads out X=1st data (data at address #1) from the memory M8 (FIG. 3D: step S133) and checks whether the data is “1” (step S134).

X=1st data in the memory M8 is data of “switch 1” as an abnormality determination target portion and is set to “1” to indicate an abnormal state. In this case, the CPU 1A reads out the current printing press state from the memory M4 (step S135) and reads out the abnormal state display target device or function from the memory M1 (step S136). The CPU 1A reads out, from the text data memory M12, text data corresponding to X=1st data in the range corresponding to the abnormal state display target device or function in the range corresponding to the current printing press state and displays the text data at Y=1st position in the display device 1E (step S137).

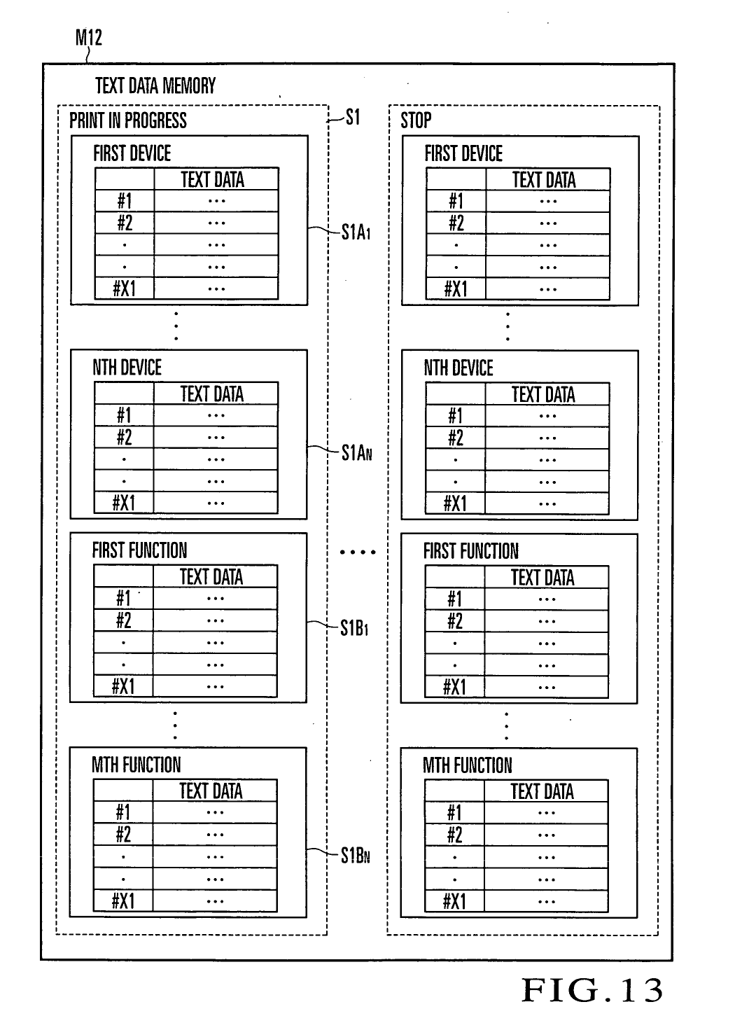

FIG. 13 shows the storage structure in the memory M12. The memory M12 stores text data corresponding to abnormality determination target portions related to the first to Nth devices and first to Mth functions in the printing press in correspondence with each printing press state. More specifically, text data corresponding to abnormality determination target portions related to the devices and functions are stored in correspondence with the abnormal state memory M19 shown in FIG. 9. In this case, the current printing press state is “print in progress”, and the abnormal state display target device or function is the first device. Hence, the CPU 1A reads out X=1st text data in the range S1A1 corresponding to the first device in the range S1 corresponding to “print in progress” from the memory M12 and displays the readout data at Y=1st position on the display device 1E (highest display position).

The CPU 1A increments the count value Y in the memory M11 by one to set Y=2 (step S138) and increments the count value X in the memory M9 by one to set X=2 (step S139). The CPU 1A reads out the current printing press state from the memory M4 (step S140) and reads out the abnormal state display target device or function from the memory M1 (step S141). On the basis of the readout current printing press state and abnormal state display target device or function, the CPU 1A also reads out, from the memory M10, the total count X1 of abnormality determination target portions corresponding to the current printing press state and abnormal state display target device or function (step S142). Then, the processing operation in steps S133 to S143 is repeated until X>X1 holds in step S243.

Of the abnormality determination target portions related to the first device in the memory M8, the abnormal states of only abnormality determination target portions determined to be abnormal are displayed on the display device 1E in descending order of significances. In this example, of the X1 abnormality determination target portions related to the first device, the abnormal states of “switch 1” and “sensor 1” are displayed by text data defined in correspondence with the abnormality determination target portions. Since the significance of “switch 1” is higher than that of “sensor 1”, the abnormal state of “switch 1” is displayed at a higher position than “sensor 1”.

As described above, in this embodiment, the abnormal states of abnormality determination target portions determined to be abnormal are displayed in descending order of significances. When measures are taken sequentially from the abnormality determination target portion displayed at the highest position, a significant abnormality is solved first, and the selected device or function can operate early. More specifically, an abnormality determination target portion with a low significance may be operable even if the abnormality remains unsolved. When the abnormal states of abnormality determination target portions are solved in descending order of significances, the selected device or function can operate at the earliest timing. [Abnormal State Detection/Display Operation: Second Time]

When X>X1 (YES in step S143), the CPU 1A confirms that the switch SW2 to return to the device or function selection menu is not ON (NO in step S144) and transmits an operation instruction to the PLC control unit 2 again (step S145).

Upon receiving the operation instruction from the central control unit 1, the CPU 2A of the PLC control unit 2 executes the above-described processing operation in steps S201 to S218 again and transmits, to the central control unit 1, the “current printing press state” and “all data in the range corresponding to the current printing press state in the memory M19”.

Upon receiving the “current printing press state” and “all data in the range corresponding to the current printing press state in the memory M19” from the PLC control unit 2 (FIG. 3B: step S109), the CPU 1A of the central control unit 1 stores the “current printing press state” in the memory M4 and “all data in the range corresponding to the current printing press state in the memory M19” in the memory M5 (step S110). [When Current Printing Press State Matches Preceding Printing Press State]

The CPU 1A reads out the preceding printing press state from the memory M2 (step S111) and compares it with the current printing press state received from the PLC control unit 2 (step S112). Assume that the preceding printing press state is “print in progress” (YES in step S112).

In this case, the CPU 1A writes “1” in the memory M6 as the count value L (step S113). The CPU 1A reads out data (γ) of L=1st abnormality determination target portion from the memory M5 storing current abnormal states (step S114) and data (δ) of L=1st abnormality determination target portion from the memory M3 storing preceding abnormal states (step S115) and compares them (step S116). [When Contents of Current Printing Press Abnormal State Match Contents of Preceding Printing Press Abnormal State]

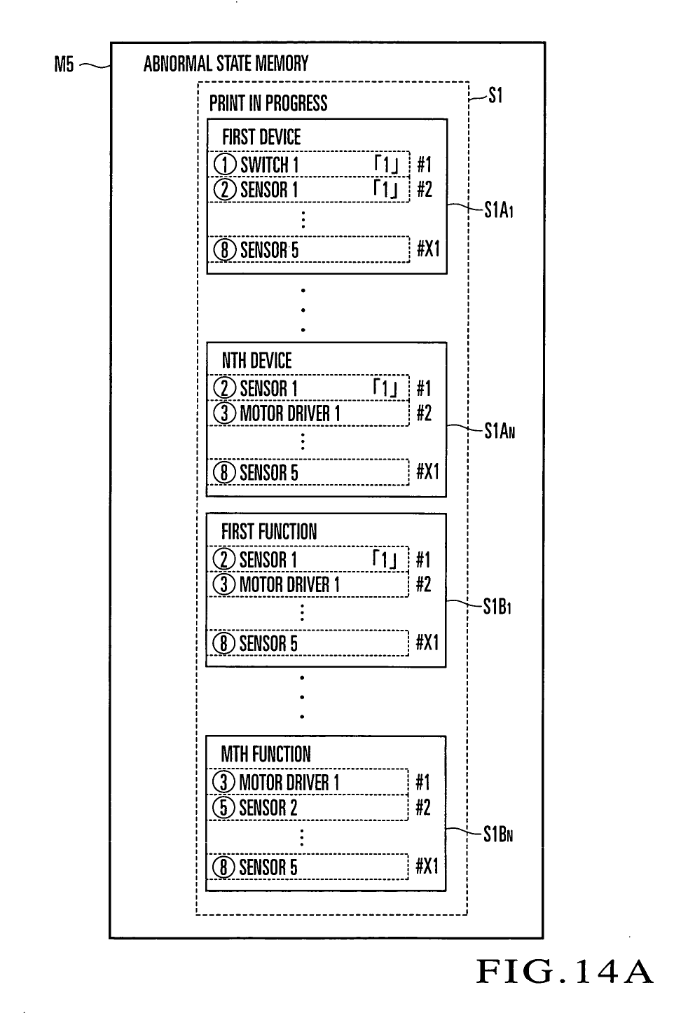

For example, assume that the contents of the current printing press abnormal state match those of the preceding printing press abnormal state, as indicated by the data storage situation in the abnormal state memory M5 shown in FIG. 14A and the data storage situation in the preceding abnormal state memory M3 shown in FIG. 14B. In this case, the data of “switch 1” as L=1st abnormality determination target portion is “1” in the current time as in the preceding time.

Hence, the CPU 1A determines that the data of L=1st abnormality determination target portion in the current time is the same as that in the preceding time (YES in step S116) and increments the count value L in the memory M6 by one (step S117). The CPU 1A reads out the current printing press state from the memory M4 (step S118), on the basis of the readout current printing press state, reads out the total count L1 of abnormality determination target portions corresponding to the current printing press state from the memory M7 (step S119), and compares the states (step S120).

In this case, the data of all abnormality determination target portions match between the memories M5 and M3. Hence, the CPU 1A repeats the processing operation in steps S114 to S120 until L>L1 holds in step S120. When L>L1, the CPU 1A transmits an operation instruction to the PLC control unit 2 again (step S121). [When Contents of Current Printing Press Abnormal State are Different From Contents of Preceding Printing Press Abnormal State]

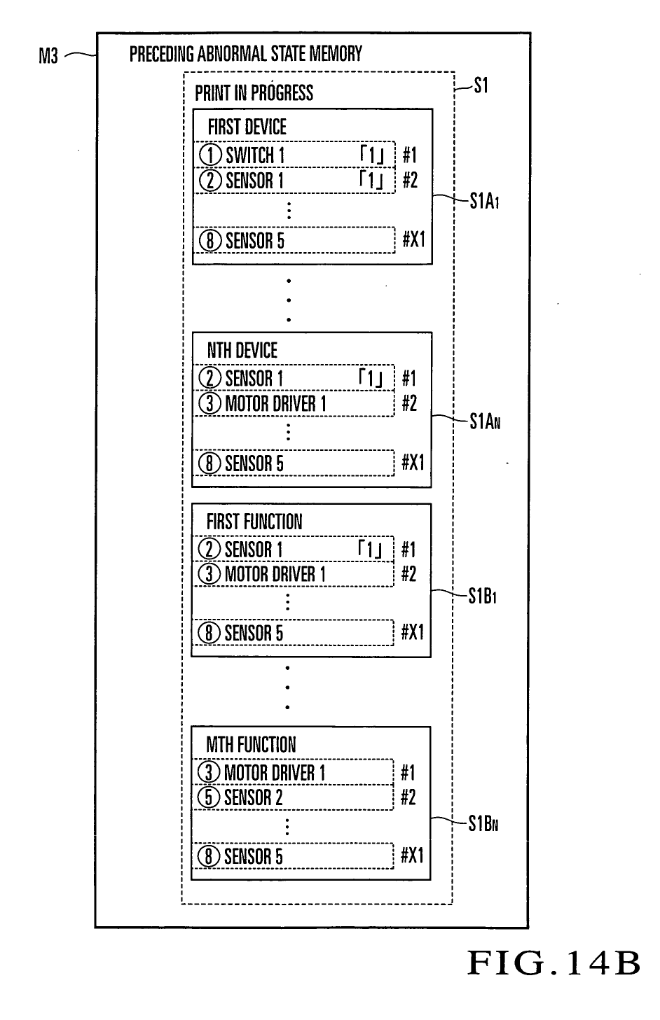

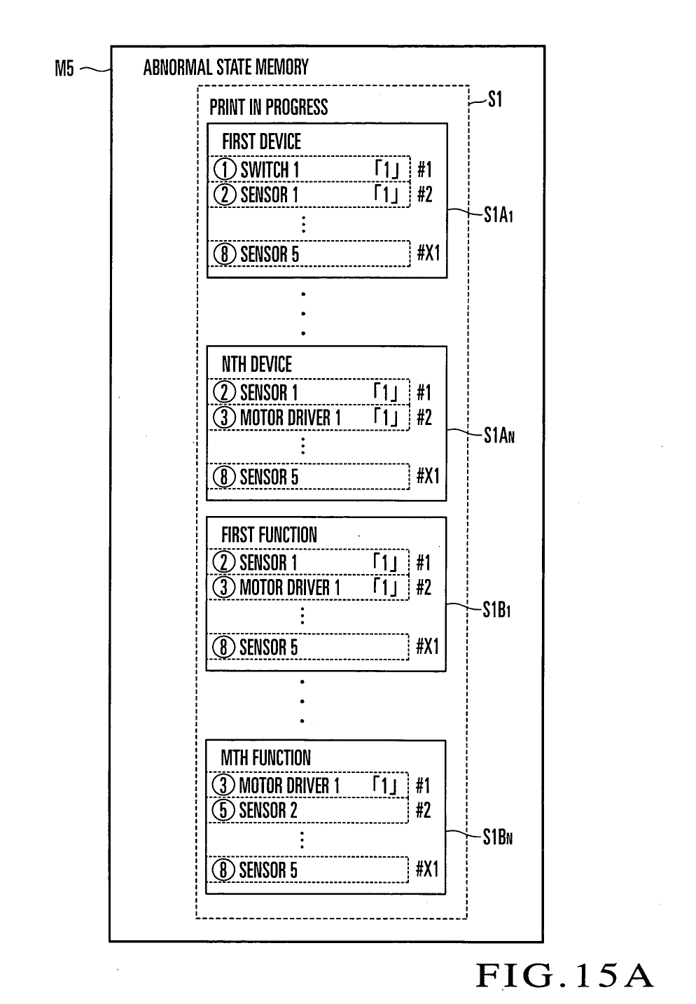

To the contrary, assume that the contents of the current printing press abnormal state are different from those of the preceding printing press abnormal state, as indicated by the data storage situation in the abnormal state memory M5 shown in FIG. 15A and the data storage situation in the preceding abnormal state memory M3 shown in FIG. 15B. In this example, “motor driver 1” as L=3rd abnormality determination target portion was normal in the preceding time but is abnormal in the current time.

In this case, the CPU 1A determines that the data of the current abnormal state are the same as those of the preceding abnormal state up to L=2nd abnormality determination target portion (YES in step S116), although the data are different at L=3rd abnormality determination target portion (NO is step S116). The flow advances to processing from step S124 shown in FIG. 3C to execute the abnormal state display operation like when the current printing press state is different from the preceding printing press state.

In this embodiment, new abnormality can be confirmed immediately by executing the processing operation in steps S112 to S121. More specifically, if the flow advances to processing from step S124 to execute the abnormal state display operation every time independently of whether the current printing press state matches the preceding printing press state, processing for the abnormal state display operation takes time, and the operation instruction to cause the PLC control unit 2 to detect the abnormal state delays. In this embodiment, however, when the current printing press state matches the preceding printing press state, the abnormal state display operation is executed only when the contents of the current printing press abnormal state are different from those of the preceding printing press abnormal state by the processing operation in steps S112 to S121. If the contents of the current printing press abnormal state match those of the preceding printing press abnormal state, the operation instruction is immediately sent to the PLC control unit 2. Hence, the PLC control unit 2 can execute the abnormality detection operation at short time intervals so that occurrence of abnormality can be detected immediately.

Upon confirming the ON state of the switch SW2 to return to the device or function selection menu during the abnormal state display operation (FIG. 3D: YES in step S144), the CPU 1A turns off the switch SW2 to return to the device or function selection menu (step S146). The flow returns to step S104 (FIG. 3A) to display the device or function selection menu on the display device 1E. Hence, the operator can select another device or function to execute the abnormal state detection/display operation, like the above-described first device.

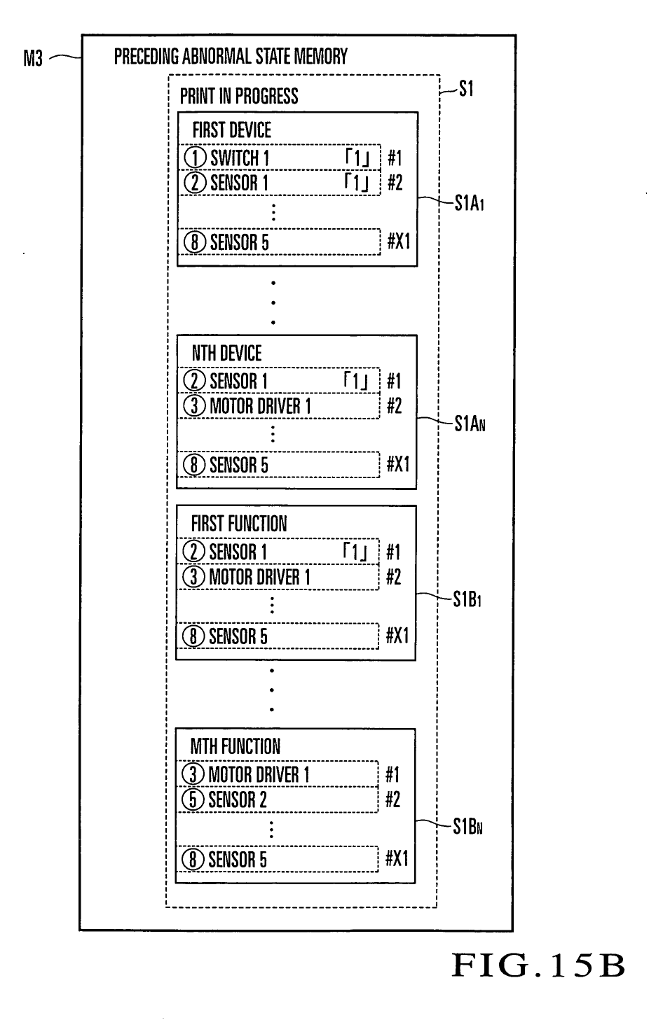

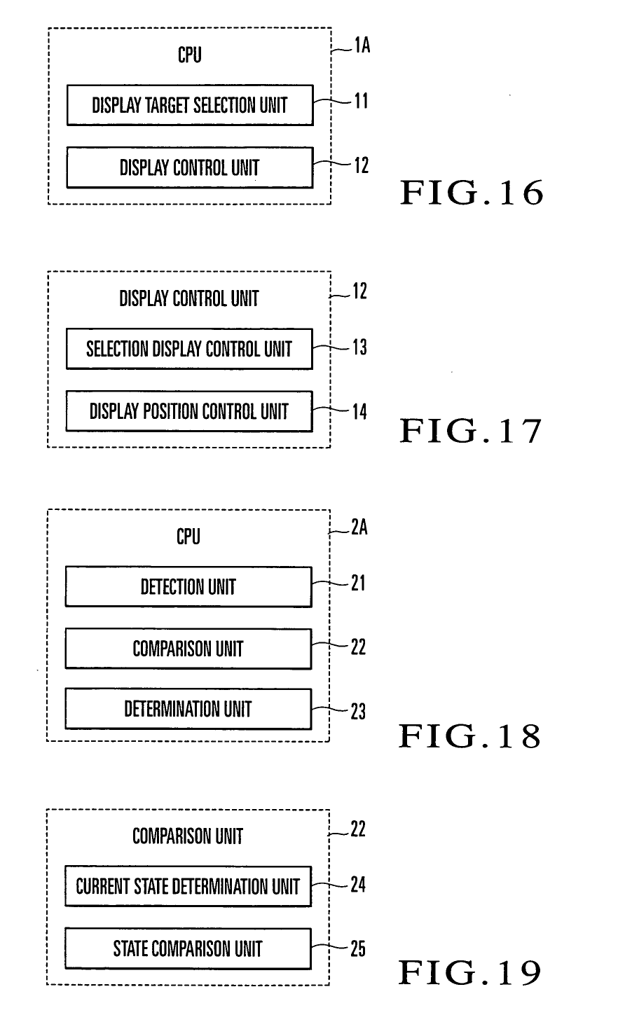

The outline of functions implemented by the CPU 1A of the central control unit 1 will be described next with reference to FIGS. 16 and 17. The CPU 1A operates in accordance with the abnormal state display program stored in the ROM 1C to implement at least a display target selection unit 11 and a display control unit 12 shown in FIG. 16. The display target selection unit 11 selects, as an abnormal state display target, a device or function designated from a plurality of devices and functions of the printing press. More specifically, the display target selection unit 11 executes processing in steps S106, S129, and S130. The display control unit 12 causes the display device 1E to display the abnormal states of only elements determined to be abnormal on the basis of the determination result by a determination unit (23) in the CPU 2A of the PLC control unit 2 (to be described later). More specifically, the display control unit 12 executes processing in steps S133 to S143.

As shown in FIG. 17, the display control unit 12 also comprises at least a selection display control unit 13 and a display position control unit 14. The selection display control unit 13 causes the display device 1E to display the abnormal states of only elements related to devices and functions selected by the display target selection unit 11. More specifically, the selection display control unit 13 executes processing in step S133. The display position control unit 14 causes the display device 1E to display element abnormal states stored in the memory M8 in descending order of significances. More specifically, the display position control unit 14 executes processing in steps S134 to S142.

The outline of functions implemented by the CPU 2A of PLC control unit 2 will be described next with reference to FIGS. 18 and 19. The CPU 2A operates in accordance with the abnormal state detection program stored in the ROM 2C to implement at least a detection unit 21, comparison unit 22, and determination unit 23 shown in FIG. 18. The detection unit 21 detects the current states of the plurality of elements of the printing press. More specifically, the detection unit 21 executes processing in step S203. The comparison unit 22 compares each current element state detected by the detection unit 21 with a normal state predetermined for the element. More specifically, the comparison unit 22 executes processing in steps S204 to S210. The determination unit 23 determines on the basis of the comparison result of the comparison unit 22 whether the current element state is abnormal. More specifically, the determination unit 23 executes processing in step S211.

As shown in FIG. 19, the comparison unit 22 also comprises at least a current state determination unit 24 and a state comparison unit 25. The current state determination unit 24 determines the current printing press state from the current element states detected by the comparison unit 22. More specifically, the current state determination unit 24 executes processing in step S204. The state comparison unit 25 compares each normal element state predetermined for the current printing press state determined by the current state determination unit 24 with the current element state. More specifically, the state comparison unit 25 executes processing in steps S205 to S210.

### Second Embodiment

A printing press abnormal state display apparatus according to the second embodiment of the present invention includes a central control unit and an abnormal state detection unit (PLC control unit).

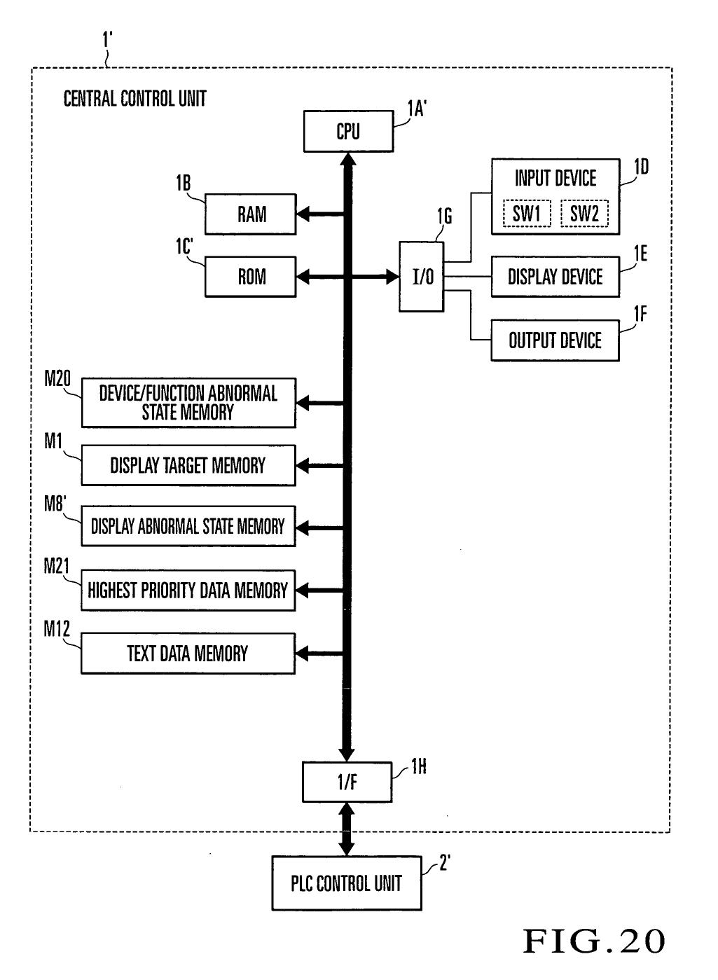

In a central control unit 1′ of this embodiment, the memories M2 or M7 and M9 to M11 used in the central control unit 1 of the first embodiment are omitted, and memories M20 and M21 are provided, as is apparent from comparison between FIGS. 20 and 1. The memory M20 is a device/function abnormal state memory to store data transmitted from a PLC control unit 2′, as will be described later, i.e., text data storage location data and priority data of abnormal abnormality determination target portions. The memory M21 is a highest priority data memory to store highest priority data. The same reference numerals as in FIG. 1 denote the same or similar constituent elements in FIG. 20, and a description thereof will be omitted.

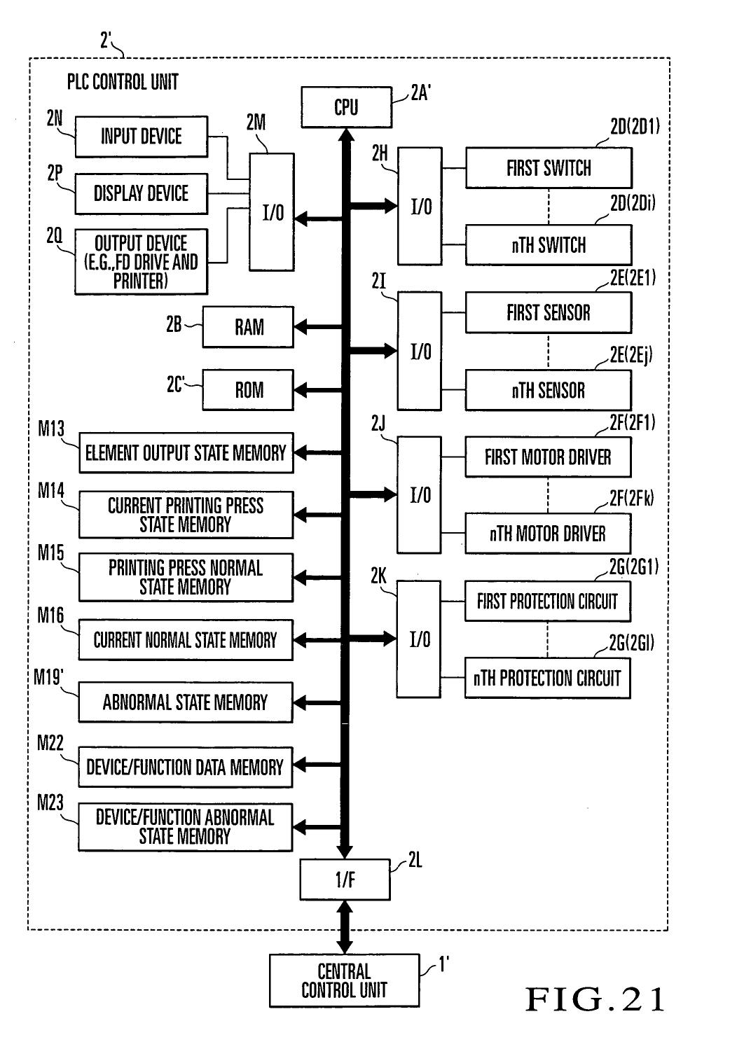

In the PLC control unit 2′ of this embodiment, the memories M17 and M18 used in the PLC control unit 2 of the first embodiment are omitted, and memories M22 and M23 are provided, as is apparent from comparison between FIGS. 21 and 2. The memory M22 is a device/function data memory to store device or function data corresponding to abnormality determination target portions and text data storage location data and priority data. The memory M23 is a device/function abnormal state memory to store, for each device or function, text data storage location data and priority data of abnormal abnormality determination target portions.

The PLC control unit 2′ also comprises an interface (I/O) 2M, input device 2N, display device 2P, and output device 2Q. The input device 2N, display device 2P, and output device 2Q are connected to a CPU 2A′ through the interface 2M. Examples of the output device 2Q are an FD drive and a printer. The same reference numerals as in FIG. 2 denote the same or similar constituent elements in FIG. 21, and a description thereof will be omitted.

Memories M8′, M19′, M20, and M23 described above store the abnormal states of elements together with their priority data.

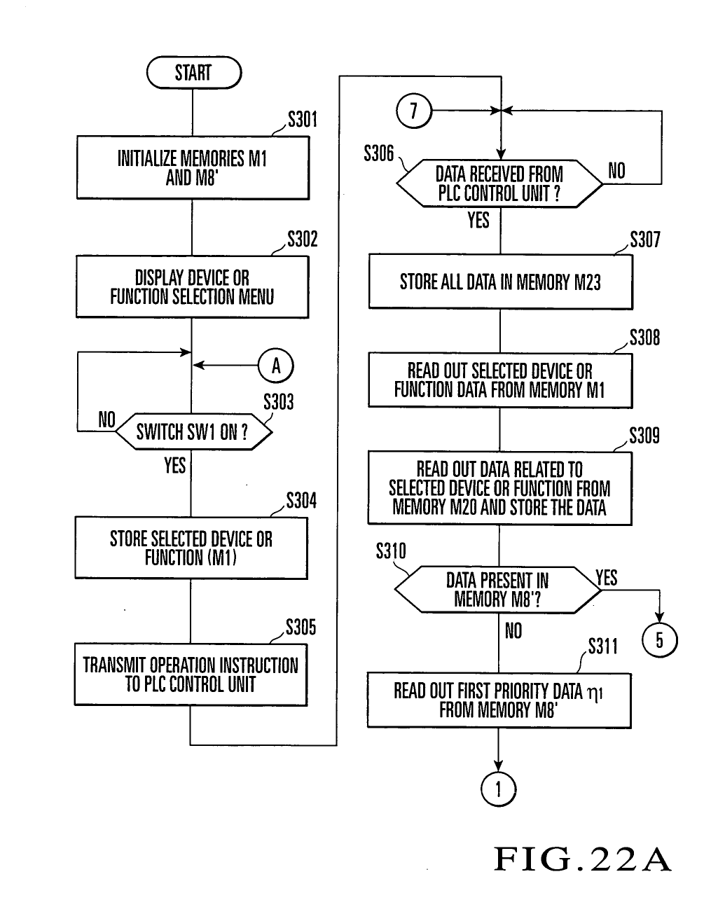

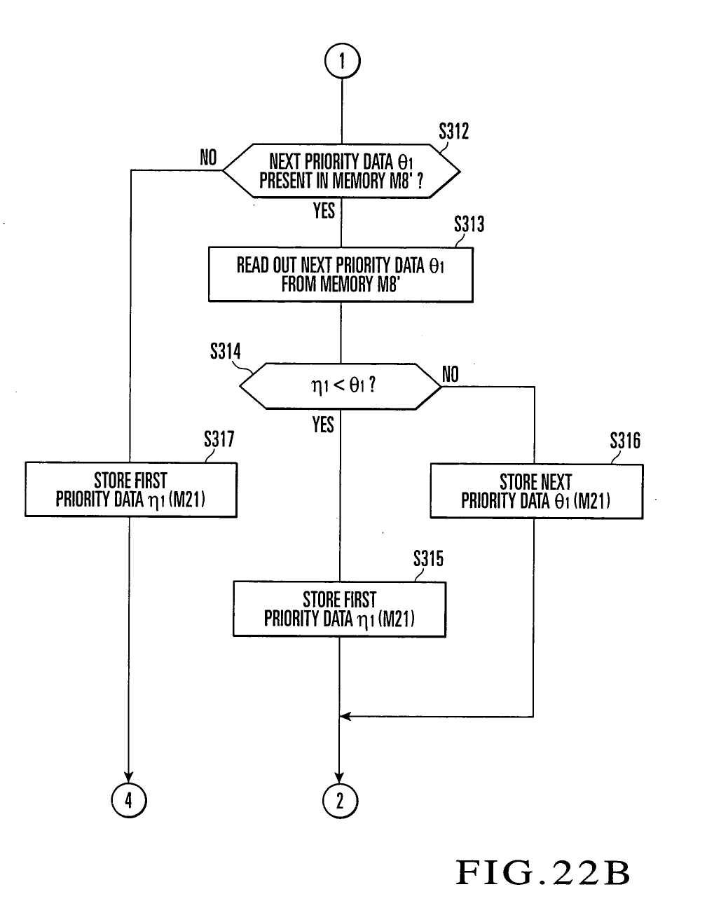

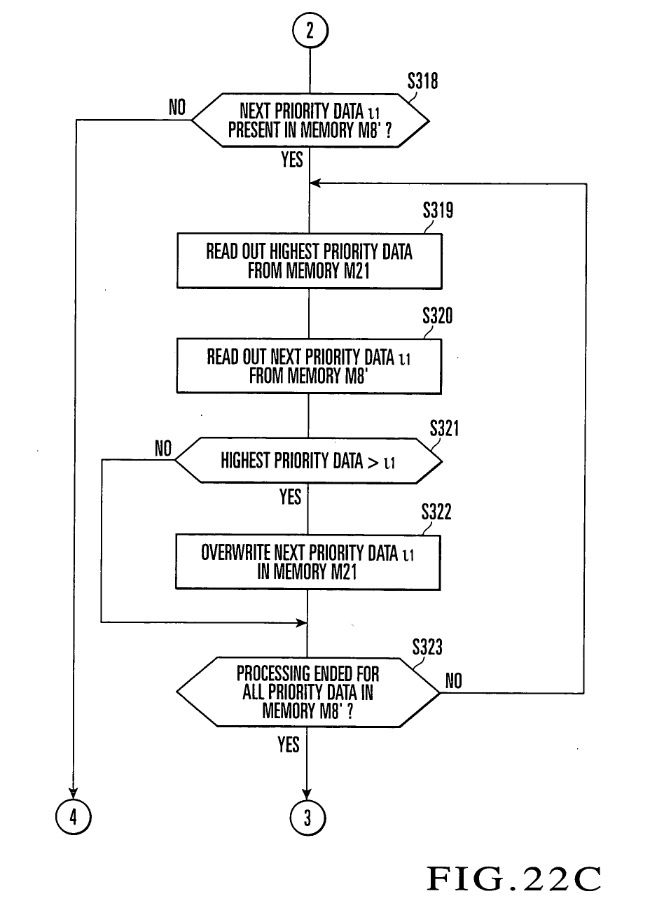

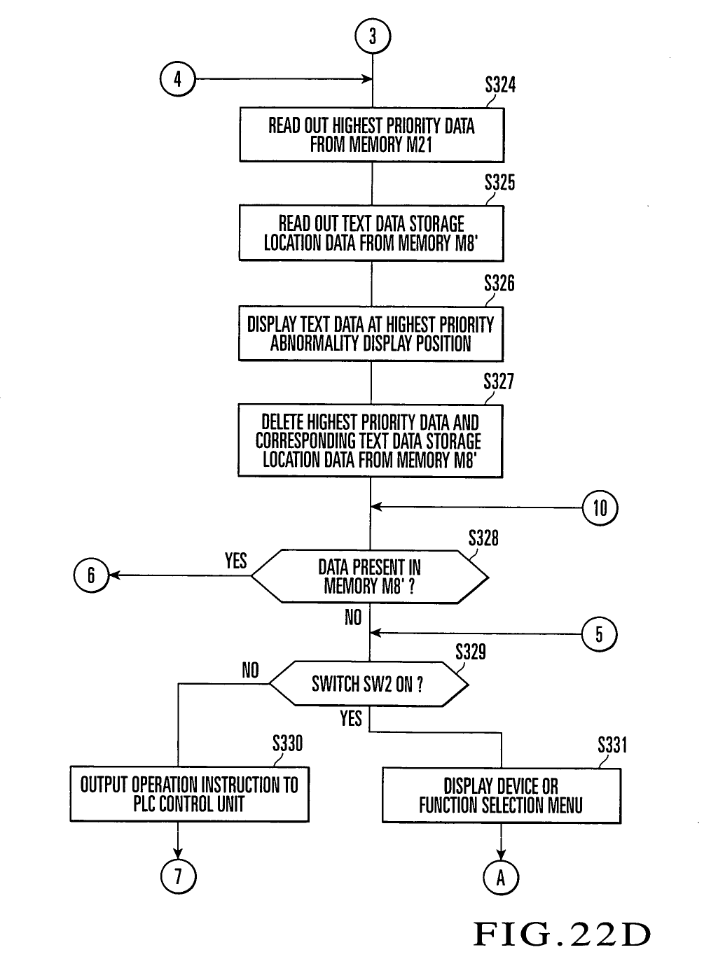

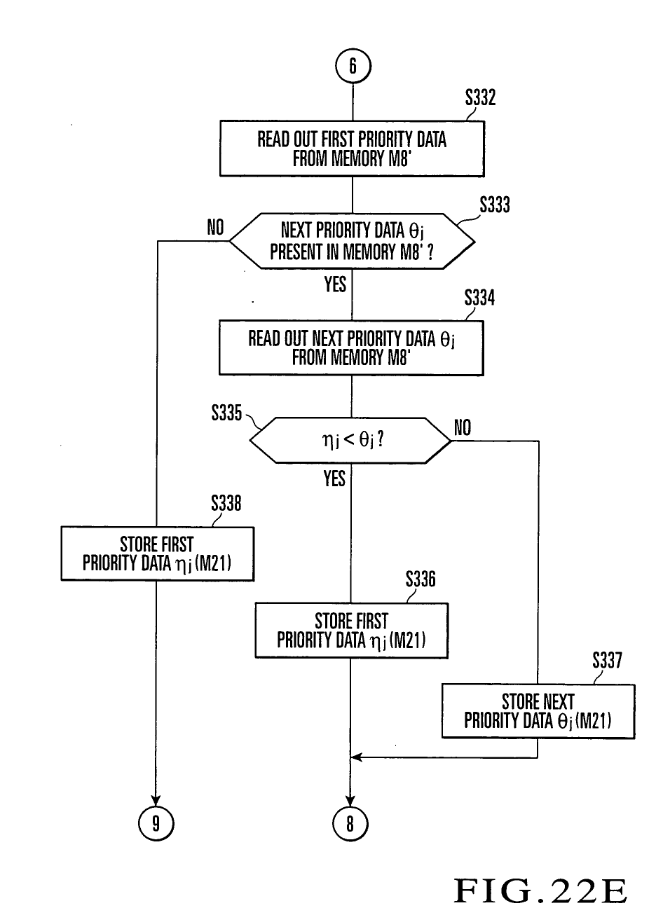

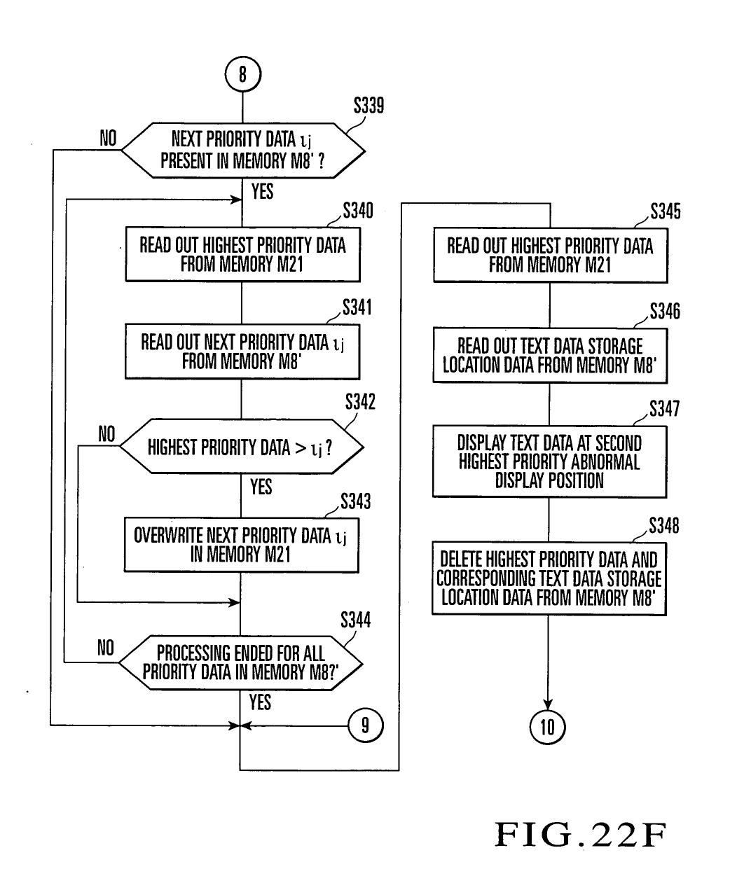

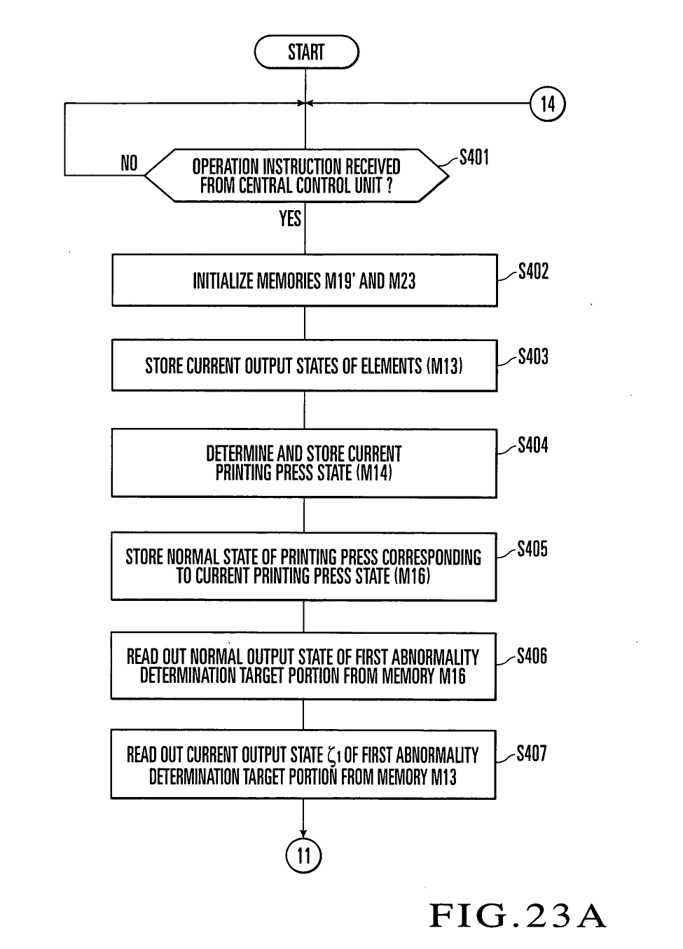

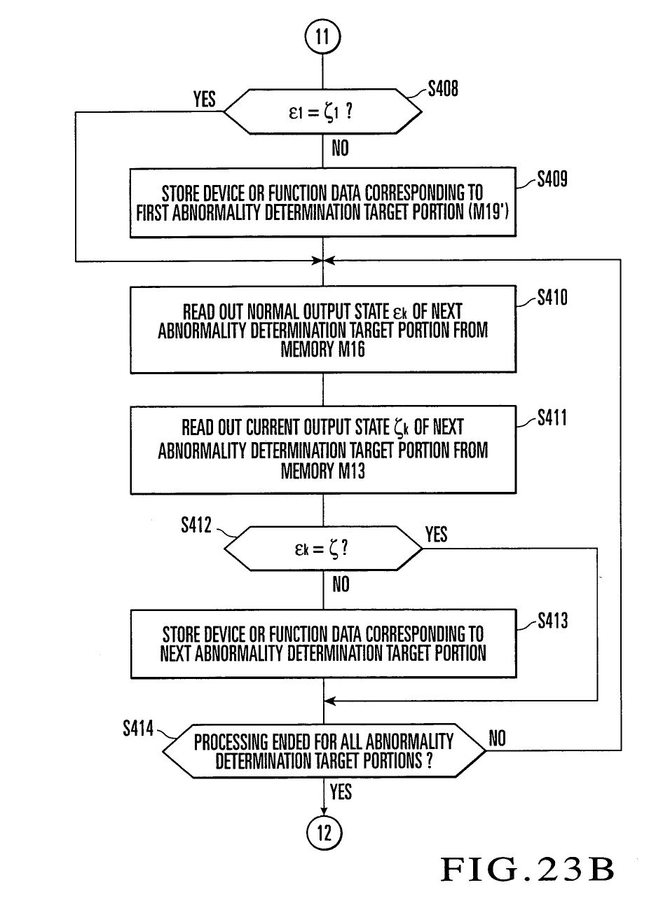

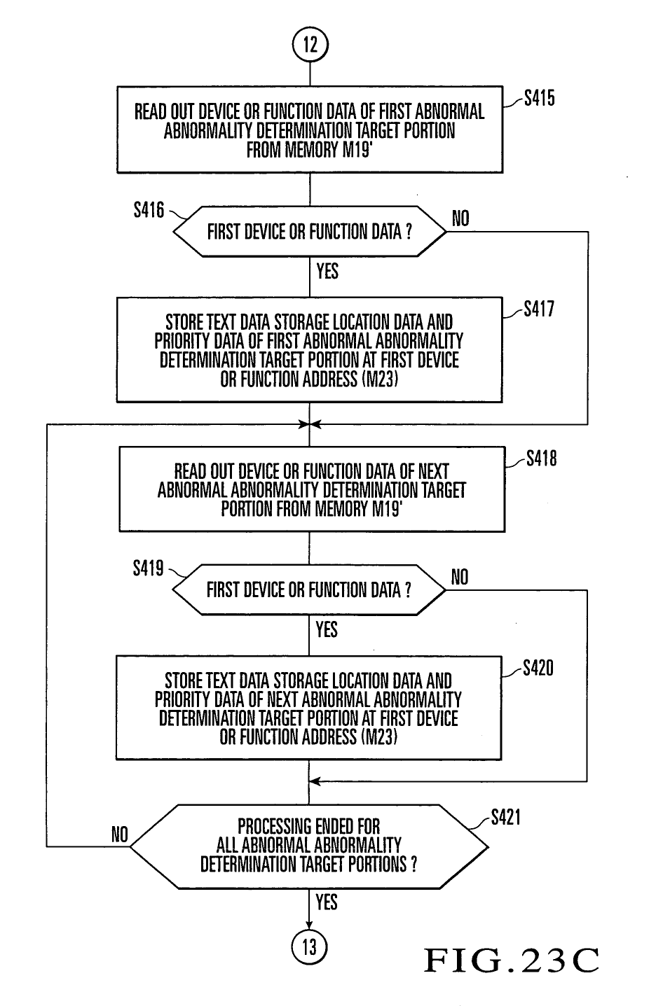

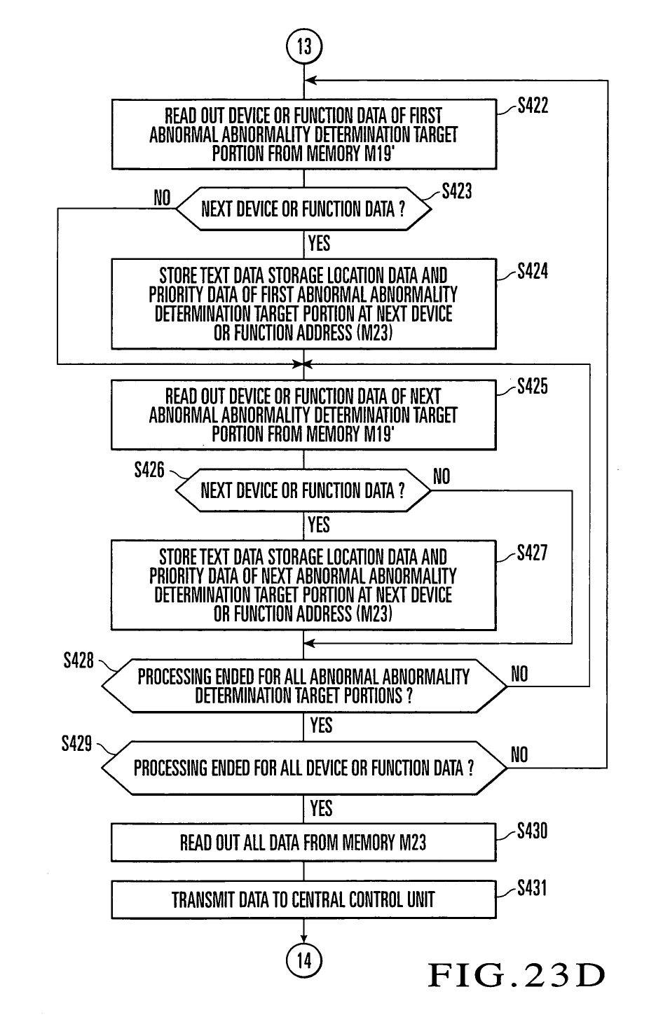

FIGS. 22A to 22F show a processing operation corresponding to an abnormal state display program executed by a CPU 1A′ of the central control unit 1′. FIGS. 23A to 23D show a processing operation corresponding to an abnormal state detection program executed by the CPU 2A′ of the PLC control unit 2′. The printing press abnormal state detection/display operation according to this embodiment, which is executed by cooperation of the central control unit 1′ and PLC control unit 2′, will be described below with reference to these flowcharts in association with the storage contents of memories M1′, M8′, M12 to M16, and M19′ to M23.

[Device or Function Selection in Central Control Unit]

Before the abnormal state detection/display operation, the CPU 1A′ of the central control unit 1′ initializes the memories M1 and M8′ (FIG. 22A: step S301). A device or function selection menu is displayed on a display device 1E (step S302). Various kinds of devices in the printing press and various kinds of functions in the printing press are displayed in the device or function selection menu. In this embodiment, first to Nth devices are provided in the printing press as devices, and first to Mth functions are provided in the printing press as functions.

The operator who wants to know an abnormal state in the printing press selects a desired device or function (abnormal state display target) from the device or function selection menu displayed on the display device 1E and turns on a device or function selector switch SW1. Assume that the operator selects the first device as the abnormal state display target and turns on the device or function selector switch SW1. The CPU 1A′ confirms the ON state of the device or function selector switch SW1 (YES in step S303) and stores, in the memory M1, the selected first device as the abnormal state display target (abnormal state display target device) (step S304) and sends an operation instruction to the PLC control unit 2′ (step S305).

[Abnormal State Detection in PLC Control Unit]

[Storage of Current Output States of Elements (Abnormality Determination Target Portions) of Printing Press]

Upon receiving the operation instruction from the central control unit 1′ (FIG. 23A: YES in step S401), the CPU 2A′ of the PLC control unit 2′ initializes the abnormal state memory M19′ and device or function abnormal state memory M23 (step S402). The output states of switches 2D1 to 2Di, sensors 2E1 to 2Ej, motor drivers 2F1 to 2Fk, and protection circuits 2G1 to 2Gl are read as the current output states of the elements (abnormality determination target portions) of the printing press and stored in the memory M13 (step S403: FIG. 5).

[Determination of Current Printing Press State]

The CPU 2A′ determines, on the basis of the read current output states of the elements (abnormality determination target portions) of the printing press, the current printing press state, i.e., “print in progress”, “stop”, or the like and stores the determined current printing press state in the memory M14 (step S404). A description will be done here assuming that the current printing press state is determined to be “print in progress”. In this case, information representing “print in progress” is stored in the memory M14 as the current printing press state (FIG. 6). [Storage of Normal State of Printing Press Corresponding to Current Printing Press State]

The CPU 2A′ reads out a corresponding normal state of the printing press from the memory M15 (FIG. 7) on the basis of the current printing press state determined in step S404 and stores the normal state in the memory M16 (FIG. 8) (step S405).

[Comparison Between Current Output State and Normal Output State of Each Abnormality Determination Target Portion and Normality/Abnormality Determination]

The CPU 2A′ reads out the normal output state (ε₁) of first abnormality determination target portion from the memory M16 (step S406) and, from the memory M3, the current output state (ζ1) of the abnormality determination target portion corresponding to the first abnormality determination target portion in the memory M16 (step S407) and compares the two output states (FIG. 23B: step S408).

If the normal output state of the first abnormality determination target portion in the memory M16 matches the current output state of the corresponding abnormality determination target portion in the memory M13 (YES in step S408), the CPU 2A′ determines that the current output state of the first abnormality determination target portion is normal, and the flow directly advances to step S410.

If the normal output state of the first abnormality determination target portion in the memory M16 does not match the current output state of the corresponding abnormality determination target portion in the memory M13 (NO in step S408), device or function data, text data storage location data, and priority data are read out from an address in the memory M22, which corresponds to the first abnormality determination target portion in the memory M16, and stored in the memory M19′ as the abnormal state data of the first abnormal abnormality determination target portion (step S409).

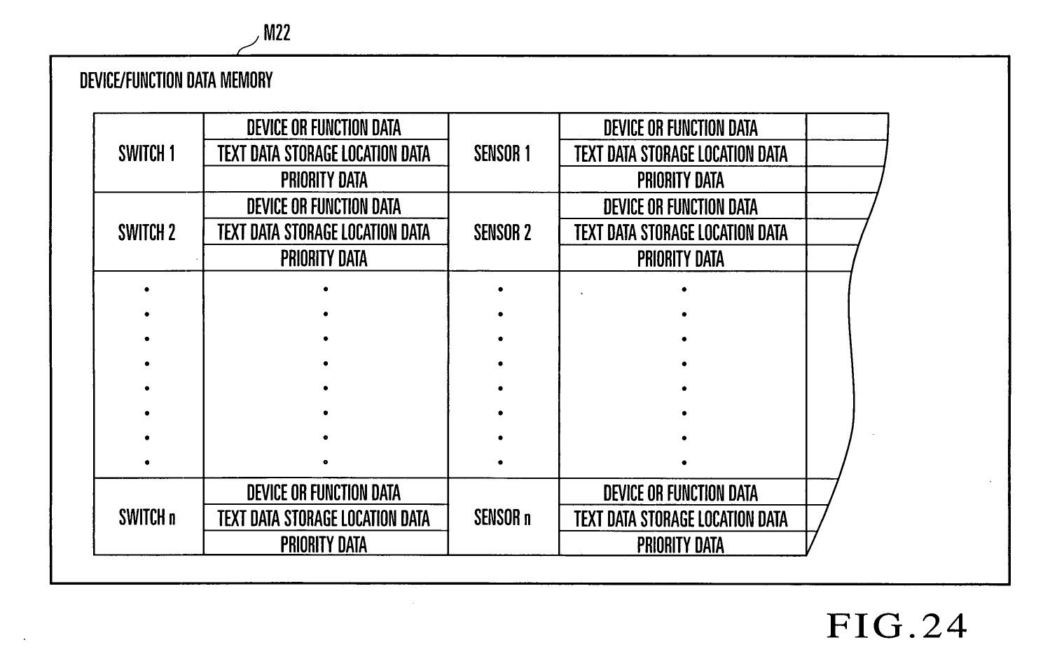

FIG. 24 shows the storage structure in the memory M22. The memory M22 stores device or function data representing a related device or function, text data storage location data representing the storage location of text data to display an abnormal state, and priority data representing the priority of abnormal state display in correspondence with each abnormality determination target.

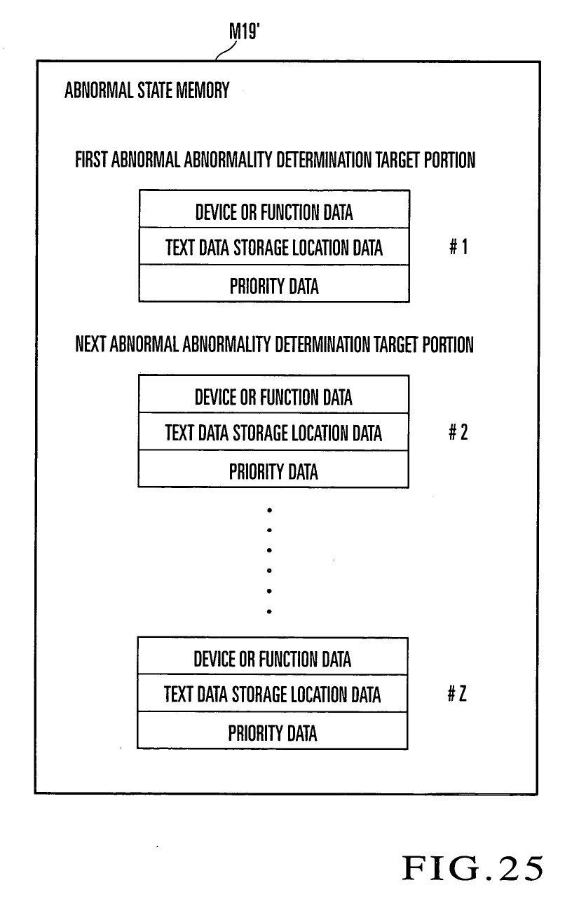

Assume that the first abnormality determination target portion in the memory M16 is “switch 1”. If the normal output state of “switch 1” does not match the current output state of the corresponding abnormality determination target portion in the memory M13, the CPU 2A′ reads out device or function data, text data storage location data, and priority data from the address of “switch 1” in the memory M22 and stores them in the memory M19′ as abnormal state data (#1) of the first abnormal abnormality determination target portion (FIG. 25).

The CPU 2A′ reads out the normal output state (εₖ) of the next abnormality determination target portion from the memory M16 (step S410) and, from the memory M13, the current output state (ζₖ) of the abnormality determination target portion corresponding to the next abnormality determination target portion in the memory M16 (step S411) and compares the two output states (step S412).

If the normal output state of the next abnormality determination target portion in the memory M16 matches the current output state of the corresponding abnormality determination target portion in the memory M13 (YES in step S412), the CPU 2A′ determines that the current output state of the next abnormality determination target portion is normal, and the flow directly advances to step S414.

If the normal output state of the next abnormality determination target portion in the memory M16 does not match the current output state of the corresponding abnormality determination target portion in the memory M13 (NO in step S412), device or function data, text data storage location data, and priority data are read out from an address in the memory M22, which corresponds to the next abnormality determination target portion in the memory M16, and stored in the memory M19′ as the abnormal state data of the next abnormal abnormality determination target portion (step S413: FIG. 25).

Similarly, the processing operation in steps S410 to S414 is repeated until processing of all abnormality determination target portions is ended in step S414. With this processing, the normality/abnormality of the current output states of all abnormality determination target portions in the memory M16 is determined. The device or function data, text data storage location data, and priority data of abnormal abnormality determination target portions are sequentially stored in the memory M19′.

[Storage of Abnormal State of Each Device or Function]

When processing is ended for all abnormality determination target portions in the memory M16 (YES in step S414), the CPU 2A′ reads out the device or function data of the first abnormal abnormality determination target portion from the memory M19′ (FIG. 23C: step S415). It is checked whether the device or function represented by the readout device or function data of the first abnormal abnormality determination target portion is the first device or function (step S416).

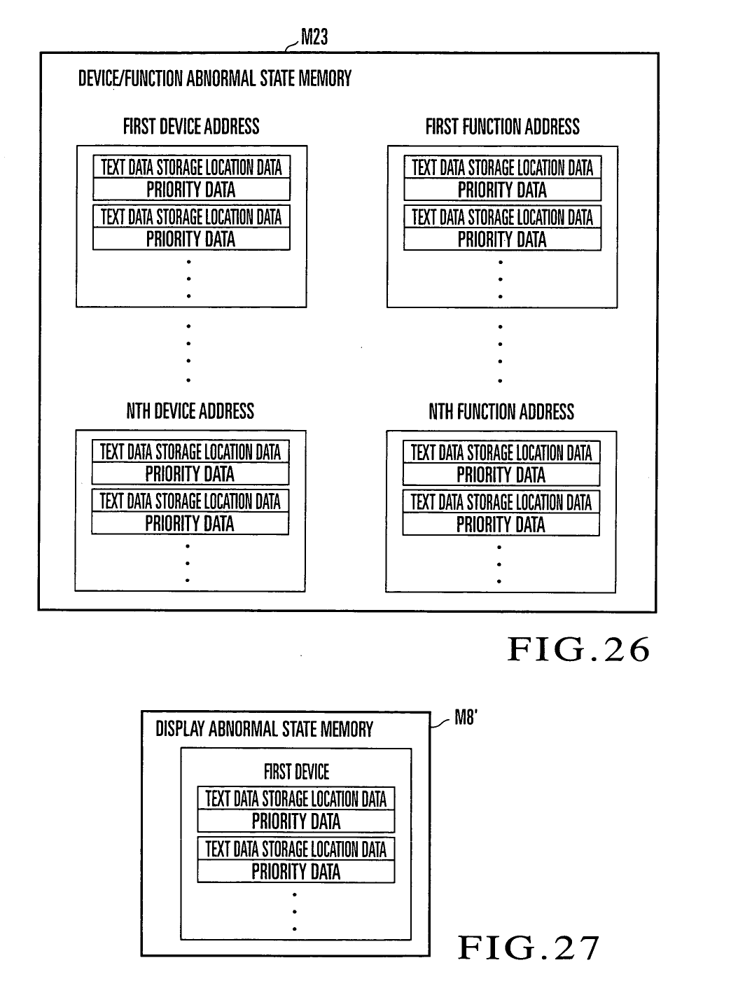

If it is the first device or function (YES in step S416), the CPU 2A′ reads out, from the memory M19′, the text data storage location data and priority data of the first abnormal abnormality determination target portion and writes the readout data at the first device or function address in the memory M23 (step S417, FIG. 26). In this embodiment, the first to Nth devices are arranged in this order, and the first to Mth functions are arranged in this order so that the device or function data are stored in the device or function data memory M22 in this order. Hence, the “first device or function” is the first device or function.

The CPU 2A′ reads out the device or function data of the next abnormal abnormality determination target portion from the memory M19′ (step S418). It is checked whether the device or function represented by the readout device or function data of the next abnormal abnormality determination target portion is the first device or function (first device or function data) (step S419). If it is the first device or function (YES in step S419), the CPU 2A′ reads out, from the memory M19′, the text data storage location data and priority data of the next abnormal abnormality determination target portion and writes the readout data at the first device or function address in the memory M23 (step S420, FIG. 26).

Similarly, the processing operation in steps S418 to S421 is repeated until processing of all abnormal abnormality determination target portions is ended in step S421. With this processing, it is checked whether each of the abnormal abnormality determination target portions in the memory M19′ is an abnormality determination target portion related to the first device or function. The text data storage location data and priority data of abnormal abnormality determination target portions related to the first device or function are written at the first device or function address in the memory M23.

When processing is ended for all abnormal abnormality determination target portions in the memory M19′ (YES in step S421), the CPU 2A′ reads out the device or function data of the first abnormal abnormality determination target portion from the memory M19′ (FIG. 23D: step S422). It is checked whether the device or function represented by the readout device or function data of the first abnormal abnormality determination target portion is the next device or function (second device or function) (step S423). If it is the next device or function (YES in step S423), the CPU 2A′ reads out, from the memory M19′, the text data storage location data and priority data of the first abnormal abnormality determination target portion and writes the readout data at the next device or function address in the memory M23 (step S424).

The CPU 2A′ reads out the device or function data of the next abnormal abnormality determination target portion from the memory M19′ (step S425). It is checked whether the device or function represented by the readout device or function data of the next abnormal abnormality determination target portion is the next device or function (step S426). If it is the next device or function (YES in step S426), the CPU 2A′ reads out, from the memory M19′, the text data storage location data and priority data of the next abnormal abnormality determination target portion and writes the readout data at the next device or function address in the memory M23 (step S427).

Similarly, the processing operation in steps S425 to S428 is repeated until processing of all abnormal abnormality determination target portions is ended in step S428. In addition, the processing operation in steps S422 to S429 is repeated until processing of all devices or functions up to the Nth device or function is ended in step S429. With this processing, the text data storage location data and priority data of abnormal abnormality determination target portions in the memory M19′, which are related to the device or function, are written at all device or function addresses in the memory M23.

When the processing is ended for all devices or functions, the CPU 2A′ reads out, from the memory M23, the text data storage location data and priority data of abnormal abnormality determination target portions of each function or device (step S430) and transmits the them to the central control unit 1′ (step S431).

[Abnormal State Display in Central Control Unit]

The CPU 1A′ of the central control unit 1′ receives the “text data storage location data and priority data of abnormal abnormality determination target portions of each function or device” from the PLC control unit 2′ (FIG. 22A: YES in step S306) and stores these data in the device or function abnormal state memory M20 (step S307). The CPU 1A′ reads out an abnormal state display target device or function from the memory M1 (step S308). Of data stored in the memory M20, text data storage location data and priority data of all abnormal abnormality determination target portions are read out from the address of the abnormal state display target device or function (first device in this example) and stored in the display abnormal state memory M8′ (step S309, FIG. 27).

The CPU 1A′ checks whether data is present in the memory M8′ (step S310). If data exists (YES in step S310), the first priority data (n1) is read out from the memory M8′ (step S311). It is checked whether the next priority data (θ₁) is present in the memory M8′ (FIG. 22B: step S312). If the next priority data (θ₁) is not present (NO in step S312), the first priority data (η₁) is stored in the highest priority data memory M21 (step S317), and the flow directly advances to step S324 (FIG. 22D).

If the next priority data (θ₁) is present in step S312 (YES in step S312), the CPU 1A′ reads out the priority data (θ₁) (step S313) and compares the first priority data (η₁) with the next priority data (θ₁) (step S314). If the priority of the first priority data (η₁) is higher (YES in step S314), the first priority data (η₁) is stored in the highest priority data memory M21 (step S315). If the priority of the next priority data (θ₁) is higher (NO in step S314), the next priority data (θ₁) is stored in the highest priority data memory M21 (step S316).

The CPU 1A′ checks whether the next priority data (ι₁) is present in the memory M8′ (FIG. 22C: step S318). If the next priority data (ι₁) is not present (NO in step S318), the flow directly advances to step S324 (FIG. 22D).

If the next priority data (ι₁) is present (YES in step S318), the CPU 1A′ reads out the highest priority data from the memory M21 (step S319) and the next priority data (ι₁) from the memory M8′ (step S320) and compares the readout highest priority data with the next priority data (ι₁) (step S321). If the priority of the highest priority data is higher (NO in step S321), the storage contents of the highest priority data memory M21 are left unchanged, and the flow advances to step S323. If the priority of the highest priority data is lower (YES in step S321), the next priority data (ι₁) is overwritten in the highest priority data memory M21 (step S322), and the flow advances to step S323.

The processing operation in steps S319 to S323 is repeated until processing of all priority data in the memory M8′ is ended in step S323. With this processing, the priority data with the highest priority in the memory M8′ is stored in the highest priority data memory M21.

When processing is ended for all priority data in the memory M8′ (YES in step S323), the CPU 1A′ reads out the highest priority data from the memory M21 (FIG. 22D: step S324) and text data storage location data corresponding to the highest priority data from the memory M8′ (step S325). Text data is read out from an address in the memory M12, which is specified by the readout text data storage location data, and displayed at the highest priority abnormality display position of the display device 1E (step S326).

Then, the CPU 1A′ deletes the highest priority data and text data storage location data paired with the highest priority data from the memory M8′ (step S327) and checks whether the next data is present in the memory M8′ (step S328). If the next data is present in the memory M8′ (YES in step S328), the first priority data (η₁) is read out from the memory M8′ (FIG. 22E: step S322), and processing in steps S333 to S348 (FIG. 22F) is executed as in steps S312 to S327. Note that in step S347, text data corresponding to the highest priority data of this time is displayed at an abnormality display position with priority next to the text data display position of the preceding time.

In the same way, the processing operation in steps S332 to S348 is repeated until no data remains in the memory M8′ ins step S328. With this processing, text data is read out from an address in the memory M12, which is specified by corresponding text data storage location data, and displayed on the display device 1E in descending order of priorities represented by the priority data stored in the memory M8′. That is, of abnormality determination target portions related to an abnormal state display target device or function, the abnormal states of abnormality determination target portions determined to be abnormal are displayed on the display device 1E in descending order of priorities (in descending order of significance).

When no data remains in the memory M8′ (NO step S328), the CPU 1A′ confirms the OFF state of a switch SW2 to return to the device or function selection menu (NO in step S329) and transmits an operation instruction to the PLC control unit 2′ again (step S330). When the ON state of the switch SW2 to return to the device or function selection menu is confirmed in step S329, the device or function selection menu is displayed on the display device 1E (step S331), and the flow returns to step S303 (FIG. 22A). Hence, the operator can select another device or function to execute the abnormal state detection/display operation, like the above-described first device.

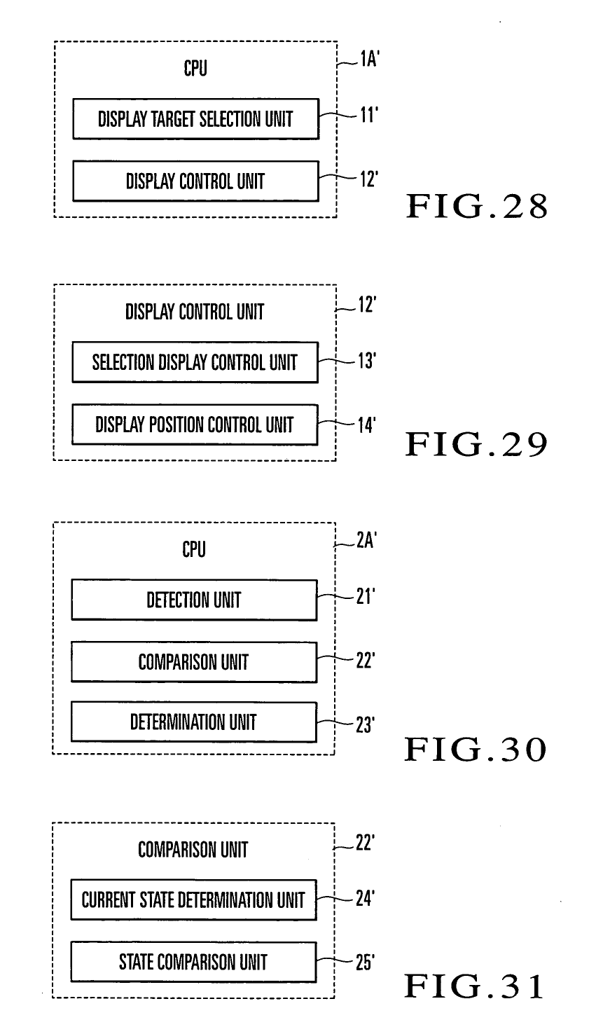

The outline of functions implemented by the CPU 1A′ of the central control unit 1′ will be described next with reference to FIGS. 28 and 29. The CPU 1A′ operates in accordance with the abnormal state display program stored in a ROM 1C′ to implement at least a display target selection unit 11′ and a display control unit 12′ shown in FIG. 28. The display target selection unit 11′ selects, as an abnormal state display target, a device or function designated from a plurality of devices and functions of the printing press. More specifically, the display target selection unit 11′ executes processing in steps S304, S308, and S309. The display control unit 12′ causes the display device 1E to display the abnormal states of only elements determined to be abnormal on the basis of the determination result by a determination unit (23′) in the CPU 2A′ of the PLC control unit 2′ (to be described later). More specifically, the display control unit 12′ executes processing in steps S311 to S328 and S332 to S348.

As shown in FIG. 29, the display control unit 12′ also comprises at least a selection display control unit 13′ and a display position control unit 14′. The selection display control unit 13′ causes the display device IE to display the abnormal states of only elements related to devices and functions selected by the display target selection unit 11′. More specifically, the selection display control unit 13′ executes processing in steps S311, S313, S320, S332, S334, and S341. The display position control unit 14′ causes the display device 1E to display element abnormal states stored in the memory M8′ in descending order of priorities. More specifically, the display position control unit 14′ executes processing in steps S314 to S317, S321 to S327, S335 to S338, and S342 to S348.

The outline of functions implemented by the CPU 2A′ of PLC control unit 2′ will be described next with reference to FIGS. 30 and 31. The CPU 2A′ operates in accordance with the abnormal state detection program stored in a ROM 2C′ to implement at least a detection unit 21′, comparison unit 22′, and determination unit 23′ shown in FIG. 30. The detection unit 21′ detects the current states of the plurality of elements of the printing press. More specifically, the detection unit 21′ executes processing in step S403. The comparison unit 22′ compares each current element state detected by the detection unit 21′ with a normal state predetermined for the element. More specifically, the comparison unit 22′ executes processing in steps S404 to S408 and S410 to S412. The determination unit 23′ determines on the basis of the comparison result of the comparison unit 22′ whether the current element state is abnormal. More specifically, the determination unit 23′ executes processing in steps S409 and S413.

As shown in FIG. 31, the comparison unit 22′ also comprises at least a current state determination unit 24′ and a state comparison unit 25′. The current state determination unit 24′ determines the current printing press state from the current element states detected by the comparison unit 22′. More specifically, the current state determination unit 24′ executes processing in step S404. The state comparison unit 25′ compares each normal element state predetermined for the current printing press state determined by the current state determination unit 24′ with the current element state. More specifically, the state comparison unit 25′ executes processing in steps S405 to S408 and S410 to S412.

In the above-described first and second embodiments, an abnormal state display target device or function is selected. However, no abnormal state display target device or function need always be selected. More specifically, the overall printing press may be defined as an abnormal state display target, and of the abnormality determination target portions of this display target, the abnormal states of only abnormality determination target portions determined to be abnormal may be displayed.

As described above, according to the present invention, the current state of each element (e.g., the output state of a switch, sensor, motor driver, or protection circuit) of the printing press is compared with a normal state predetermined for the element. The normality/abnormality of the current element state is determined on the basis of the comparison result. In this case, the abnormal states of only elements determined to be abnormal on the basis of the element normality/abnormality determination result are displayed by text data or the like.

In the present invention, the overall printing press may be defined as the abnormal state display target. For example, a desired device (abnormal state display target device) in the printing press may be selected as the abnormal state display target, and the abnormal states of only elements which are related to the device selected as the abnormal state display target and determined to be abnormal may be displayed. Alternatively, a desired function in the printing press may be selected as the abnormal state display target, and the abnormal states of only elements which are related to the function (abnormal state display target function) selected as the abnormal state display target and determined to be abnormal may be displayed.

In the printing press, the normal state of each element changes depending on the current printing press state such as “print in progress” or “stop”. For example, the normal output state of a switch is “ON” during “print in progress” and “OFF” during “stop”. In the present invention, the current printing press state is determined on the basis of the current state of each element of the printing press. The normal state of the element predetermined in correspondence with the determined current printing press state is compared with the current state of the element. The abnormal states of only elements determined to be abnormal are displayed.

According to the present invention, the current state of each element of the printing press is compared with a normal state predetermined for the element. The normality/abnormality of the current element state is determined on the basis of the comparison result. The abnormal states of only elements determined to be abnormal are displayed. Since a location where abnormality occurs is easy to recognize, burden for the operator can be reduced, and any decrease in operating ratio can be prevented.

According to the present invention, the abnormal states of only elements which are related to the abnormal state display target device and determined to be abnormal are displayed. Alternatively, the abnormal states of only elements which are related to the abnormal state display target function and determined to be abnormal are displayed. Since the abnormal states can be displayed with focus on the desired device or function, a location where abnormality occurs is recognizable more easily.

According to the present invention, the current printing press state is determined on the basis of the current state of each element of the printing press. The normal state of the element predetermined in correspondence with the determined current printing press state is compared with the current state of the element. The abnormal states of only elements determined to be abnormal are displayed. Hence, the abnormal state of each element can flexibly be detected and displayed in accordance with the current printing press state such as “print in progress” or “stop”.

What is claimed is:

1. A printing press abnormal state display method comprising the steps of:
detecting current states of a plurality of elements of a printing press;
comparing the detected current state of each element with a normal state predetermined for the element;
determining on the basis of a comparison result whether the current state of the element is abnormal; and
displaying an abnormal state of only an element determined to be abnormal on the basis of a determination result.

2. A method according to claim 1, further comprising the step of selecting a device as an abnormal state display target from a plurality of devices included in the printing press,
wherein the displaying step comprises the step of displaying an abnormal state of only an element related to the selected device.

3. A method according to claim 1, further comprising the step of selecting a function as an abnormal state display target from a plurality of functions provided in the printing press,
wherein the displaying step comprises the step of displaying an abnormal state of only an element related to the selected function.

4. A method according to claim 1, wherein
the comparing step comprises the steps of
determining a current state of the printing press on the basis of the detected current state of the element, and
comparing the normal state of the element predetermined in correspondence with the determined current state of the printing press with the current state of the element.

5. A method according to claim 1, further comprising the step of storing the abnormal state of the element determined to be abnormal in display abnormal state storage means in which an area to store the abnormal state of the element is allocated in descending order of significances of the elements,
wherein the displaying step comprises the step of displaying the abnormal state of the element stored in the display abnormal state storage means in descending order of significances.

6. A method according to claim 1, further comprising the step of storing, in display abnormal state storage means for storing the abnormal state of the element, the abnormal state of the element determined to be abnormal together with priority data of the element,
wherein the displaying step comprises the step of displaying the abnormal state of the element stored in the display abnormal state storage means in descending order of priorities.

7. A method according to claim 1, further comprising the steps of
sequentially transmitting an operation instruction to operate an abnormal state detection unit from a central control unit that executes the displaying step to the abnormal state detection unit that executes the detecting step, the comparing step, and the determining step, and
sequentially transmitting the determination result from the abnormal state detection unit to the central control unit in response to the operation instruction,
wherein in the displaying step, display is not updated if the current determination result matches a preceding determination result.

8. A printing press abnormal state display apparatus comprising:
detection means for detecting current states of a plurality of elements of a printing press;
comparison means for comparing the current state of each element detected by said detection means with a normal state predetermined for the element;
determination means for determining on the basis of a comparison result by said comparison means whether the current state of the element is abnormal; and
display control means for controlling to display an abnormal state of only an element determined to be abnormal on the basis of a determination result by said determination means.

9. An apparatus according to claim 8, further comprising display target selection means for selecting a designated device as an abnormal state display target from a plurality of devices included in the printing press,
wherein said display control means comprises selection display control means for controlling to display an abnormal state of only an element related to the selected device.

10. An apparatus according to claim 8, further comprising display target selection means for selecting a designated function as an abnormal state display target from a plurality of function provided in the printing press,
wherein said display control means comprises selection display control means for controlling to display an abnormal state of only an element related to the selected function.

11. An apparatus according to claim 8, wherein
said comparison means comprises
current state determination means for determining a current state of the printing press on the basis of the current state of the element detected by said detection means, and
state comparison means for comparing the normal state of the element predetermined in correspondence with the current state of the printing press determined by said current state determination means with the current state of the element.

12. An apparatus according to claim 8, further comprising display abnormal state storage means in which an area to store the abnormal state of the element is allocated in descending order of significances of the elements,
wherein said display control means comprises display position control means for controlling to display the abnormal state of the element stored in said display abnormal state storage means in descending order of significances.

13. An apparatus according to claim 8, further comprising display abnormal state storage means for storing the abnormal state of the element determined to be abnormal by said determination means together with priority data of the element,
wherein said display control means comprises display position control means for controlling to display the abnormal state of the element stored in said display abnormal state storage means in descending order of priorities.

14. An apparatus according to claim 8, further comprising
an abnormal state detection unit including said detection means, said comparison means, and said determination means, and
a central control unit including said display control means,
wherein said central control unit further comprises transmitting/receiving means for sequentially transmitting an operation instruction to operate said detection means, said comparison means, and said determination means to said abnormal state detection unit and receiving the determination result of said determination means transmitted from said abnormal state detection unit in response to the operation instruction,
wherein said display control means does not update display if the current determination result matches a preceding determination result.
